(19) United States
(12) Patent Application Publication
(10) Pub. No.: US 2024/0375559 A1
(43) Pub. Date: Nov. 14, 2024

(54) SEAT ASSEMBLY

(71) Applicant: Lear Corporation, Southfield, MI (US)

(72) Inventors: Antoine Moulin, Aurec-Sur-Loire (FR); Pierre Champmartin, Roche-la-Molière (FR)

(73) Assignee: Lear Corporation, Southfield, MI (US)

(21) Appl. No.: 18/652,458

(22) Filed: May 1, 2024

Related U.S. Application Data
(60) Provisional application No. 63/501,984, filed on May 12, 2023.

(51) Int. Cl. B60N 2/12; B60N 2/02; B60N 2/30

(52) U.S. Cl. CPC B60N 2/12; B60N 2/02253; B60N 2/0256; B60N 2/0292; B60N 2/3011; B60N 2/02258

(57) ABSTRACT

A seat assembly comprises a frame assembly, including: a base frame; a seat bottom frame rotatably coupled with the base frame; and a seatback frame rotatably coupled to the base frame. The frame assembly can include a plurality of positions, including a reclined position, a design position, an easy-entry position, and a folded position. The seat bottom frame may be engaged with the base frame and/or the seatback frame in the reclined position and the design position. The seat bottom frame may be disengaged from the base frame and/or seatback frame in the folded position.

### CROSS-REFERENCE TO RELATED APPLICATIONS

This application claims the benefit of and priority to U.S. Provisional Application 63/501,984, filed May 12, 2023, the disclosure of which is hereby incorporated by reference in its entirety as though fully set forth herein.

### TECHNICAL FIELD

The present disclosure generally relates to seat assemblies, including seat assemblies that may, for example, be used in connection with vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIGS. 1 and 2 are perspective views generally illustrating an embodiment of a seat assembly according to teachings of the present disclosure.

FIG. 3 is a side view generally illustrating an embodiment of a seat assembly in a design position according to teachings of the present disclosure.

FIG. 4 is an enlarged view showing portions of the side view of FIG. 3.

FIG. 5 is a side view generally illustrating an embodiment of a seat assembly in a reclined position according to teachings of the present disclosure.

FIG. 6 is an enlarged view showing portions of the side view of FIG. 5.

FIG. 7 is a side view generally illustrating an embodiment of a seat assembly in an easy-entry position according to teachings of the present disclosure.

FIG. 8 is an enlarged view showing portions of the side view of FIG. 7.

FIG. 9 is a side view generally illustrating an embodiment of a seat assembly in a design position according to teachings of the present disclosure.

FIG. 10 is an enlarged view showing portions of the side view of FIG. 9.

FIG. 11-13 are side views generally illustrating an embodiment of a seat assembly in a design position, an easy entry position, and a folded position, respectively, according to teachings of the present disclosure.

FIG. 14 is a schematic view generally illustrating portions of an embodiment of a seat assembly including a frame assembly and a coupling in an engaged position, according to teachings of the present disclosure.

FIG. 15 is a schematic view generally illustrating portions of an embodiment of a seat assembly including a frame assembly and a coupling in a disengaged position, according to teachings of the present disclosure.

FIG. 16 is a perspective view generally illustrating an embodiment of a seat assembly according to teachings of the present disclosure.

FIG. 17 is a sectional view generally illustrating portions of an embodiment of a seat assembly in a design position according to teachings of the present disclosure.

FIG. 18 is a sectional view generally illustrating portions of an embodiment of a seat assembly in a reclined position according to teachings of the present disclosure.

FIG. 19 is a sectional view generally illustrating portions of an embodiment of a seat assembly in an easy entry position according to teachings of the present disclosure.

FIG. 20 is a sectional view generally illustrating portions of an embodiment of a seat assembly in a folded position according to teachings of the present disclosure.

FIG. 21 is a perspective view generally illustrating an embodiment of a coupling of a seat assembly according to teachings of the present disclosure.

FIG. 22 is an exploded perspective view generally illustrating an embodiment of a coupling of a seat assembly according to teachings of the present disclosure.

FIG. 23 is a perspective view generally illustrating portions of an embodiment of a coupling, with a recliner lever hidden, of a seat assembly according to teachings of the present disclosure.

FIG. 24 is a perspective view generally illustrating portions of an embodiment of a coupling, with a coupling plate hidden, of a seat assembly according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and/or networks have not been described in detail so as not to unnecessarily obscure aspects of the embodiments.

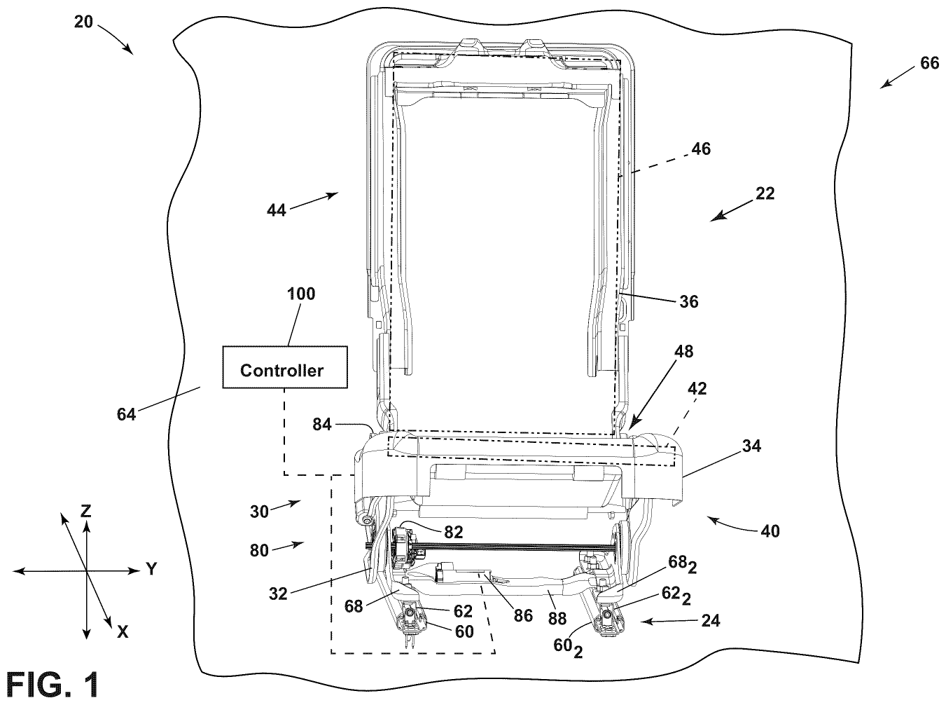

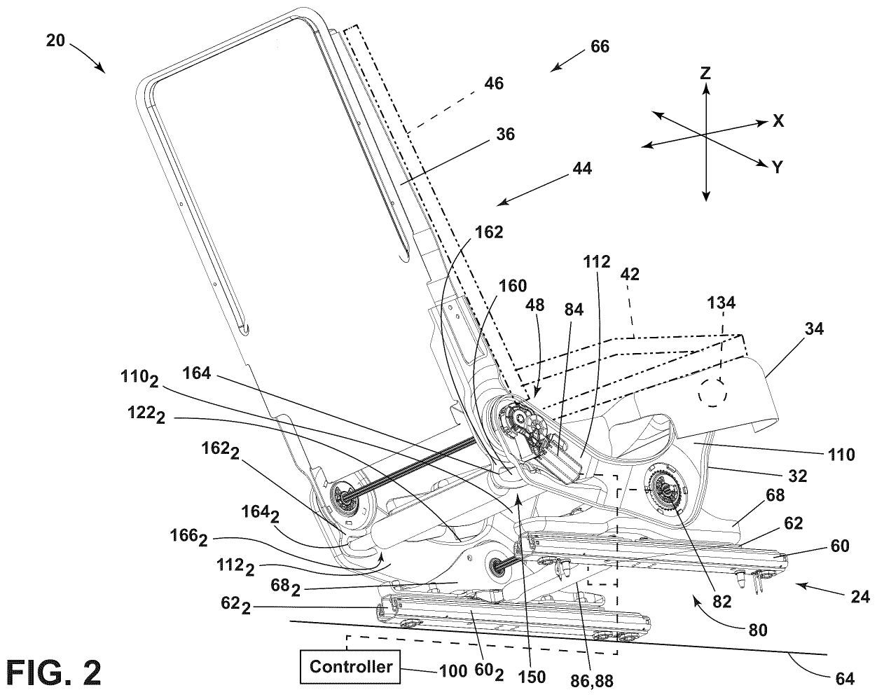

Referring to FIGS. 1 and 2, a seat assembly 20 including a seat 22 and a track assembly 24 is illustrated. The seat 22 includes a frame assembly 30 including a base frame 32, a seat bottom frame 34, and a seatback frame 36. A seat bottom 40 of the seat 22 includes the seat bottom frame 34 and a first cushion 42 connected thereto. A seatback 44 of the seat 22 includes the seatback frame 36 and a second cushion 46 connected thereto. An intersection 48 of the first cushion 42 and the second cushion 46, may be referred to as a bite line.

The track assembly 24 includes a first track 60 and a second track 62 slidably coupled with the first track 60. The first track 60 is configured to be connected (e.g., fixed) to a mounting surface 64 and can function as a fixed track. The second track 62 can function as a movable track via which the seat 22 can move (e.g., slide, translate, etc.) relative to the mounting surface 64. In some configurations, the mounting surface 64 includes a floor of vehicle 66. The second track 62 or the frame assembly 30 can include a mounting bracket 68 that may extend, at least to some degree, upward from the second track 62. With some configurations, the mounting bracket 68 is rigidly fixed to the second track 62. The base frame 32 can be rotatably coupled to the mounting bracket 68 such that the base frame 32 is rotatably coupled to the second track 62 via the mounting bracket 68.

In some examples, the track assembly 24 includes an additional first track 602 and an additional second track 622 slidably coupled with the additional first track 602 and including an additional mounting bracket 682. The base frame 32 can be rotatably coupled to the additional second track 622 and/or the additional mounting bracket 682, such as in addition to or instead of the second track 62 and/or the mounting bracket 68. The tracks 60, 602, 62, 622 may extend in a longitudinal direction X.

The seat assembly 20 can include a motor assembly 80, which can include a first motor 82, a second motor 84, and/or a third motor 86. The first motor 82 is coupled with the base frame 32 and/or the mounting bracket 68 to rotate the base frame 32 relative to the mounting bracket 68 and the second track 62. In some configurations, the first motor 82 is attached to the mounting bracket 68 such that the base frame 32 rotates relative to the first motor 82. In some configurations, the first motor 82 is attached to the base frame 32 such that the first motor 82 moves with the base frame 32 relative to the mounting bracket 68. Optionally, the first motor 82 includes and/or is connected to a recliner.

The second motor 84 is coupled with the seatback frame 36 to rotate the seatback frame 36 relative to the base frame 32 and/or to rotate the base frame 32 relative to the seatback frame 36. In some configurations, the second motor 84 is attached to the base frame 32 such that the seatback frame 36 rotates relative to the second motor 84. In some other configurations, the second motor 84 is attached to the seatback frame 36 such that the second motor 84 moves with the seatback frame 36 relative to the base frame 32. Optionally, the second motor 84 includes and/or is connected to a recliner.

The third motor 86 is coupled with the track assembly 24 to move (e.g., slide, translate, etc.) the second track(s) 62, 622 relative to the first track(s) 60, 602. In some configurations, the third motor 86 is attached to the second track(s) 62, 622 such that the third motor 86 moves with the second track(s) 62, 622 relative to the first track(s) 60, 602. For example, a cross member 88 may at least partially support the third motor 86 on second tracks 62, 622. In some other configurations, the third motor 86 is attached to the first track(s) 60, 602 such that the second track(s) 62, 622 move relative to the third motor 86.

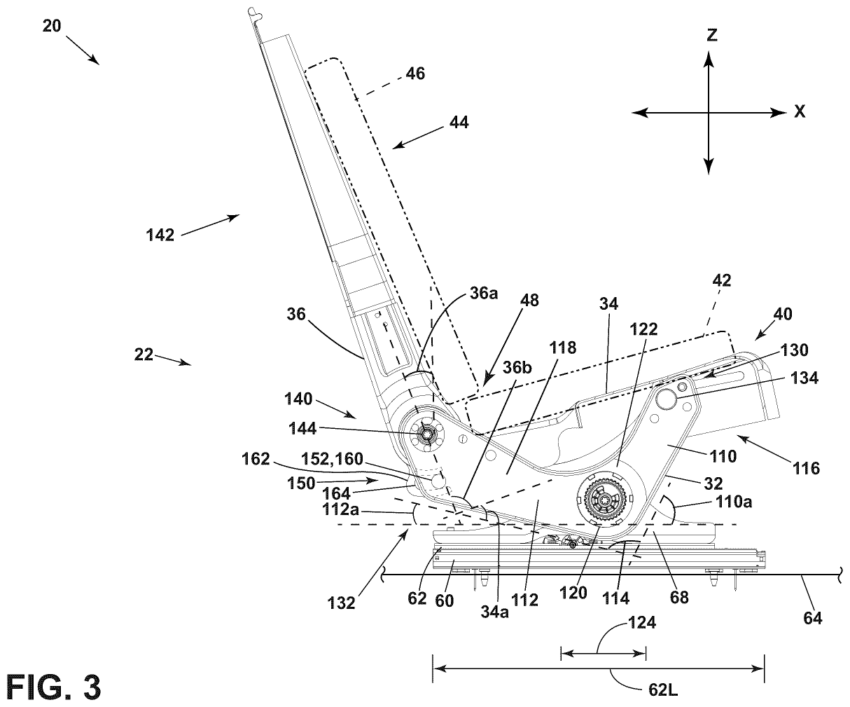

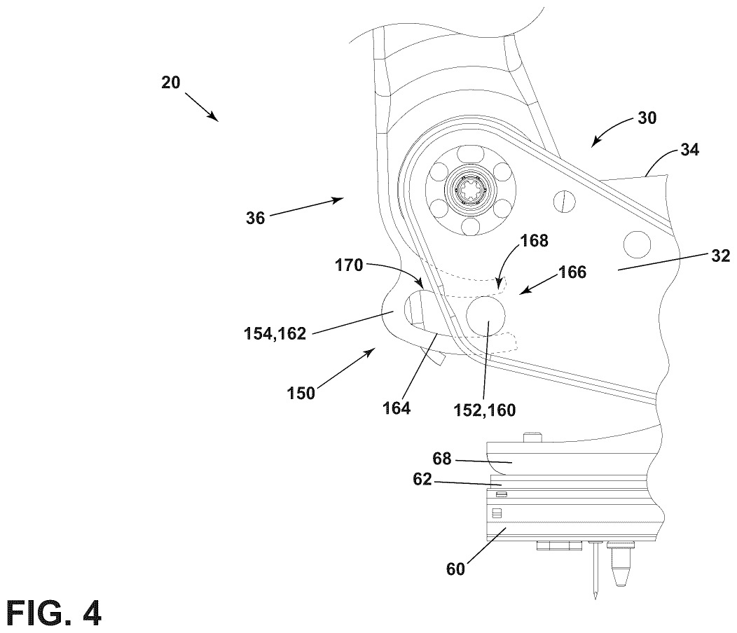

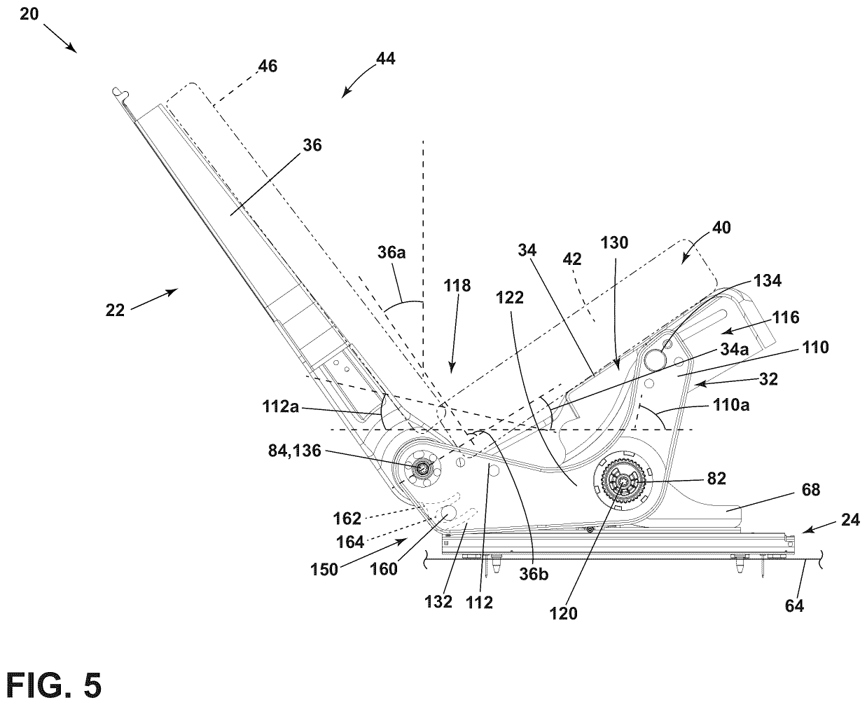

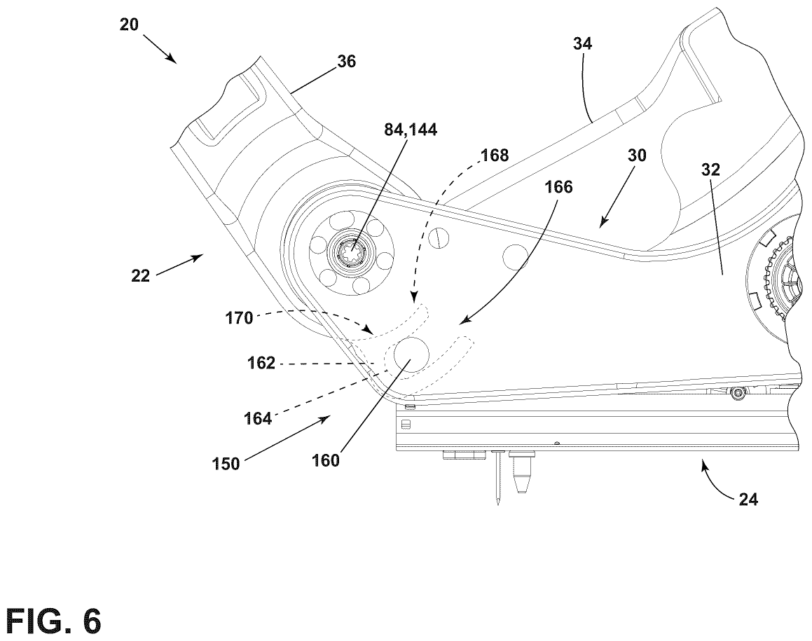

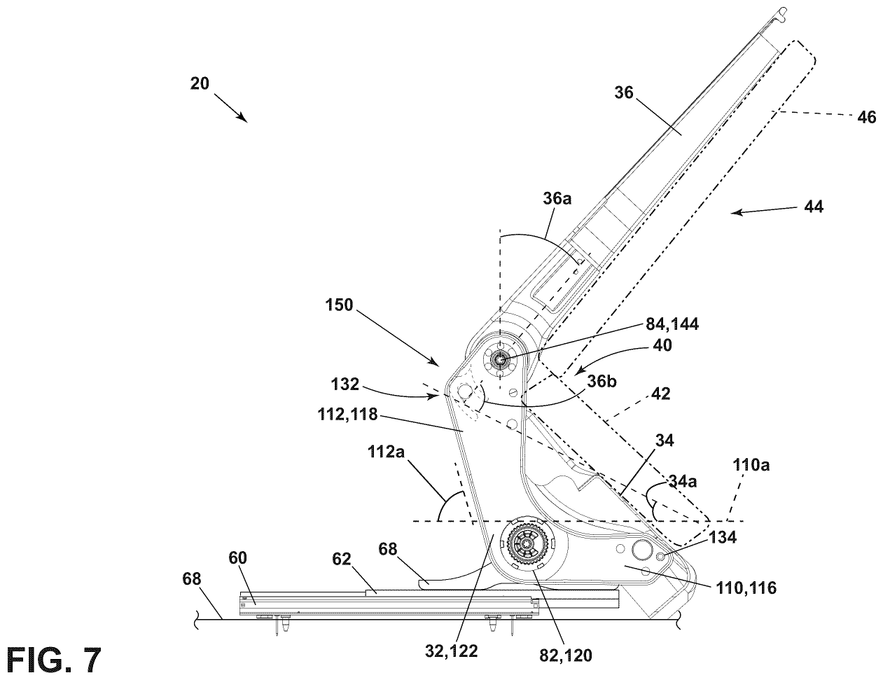

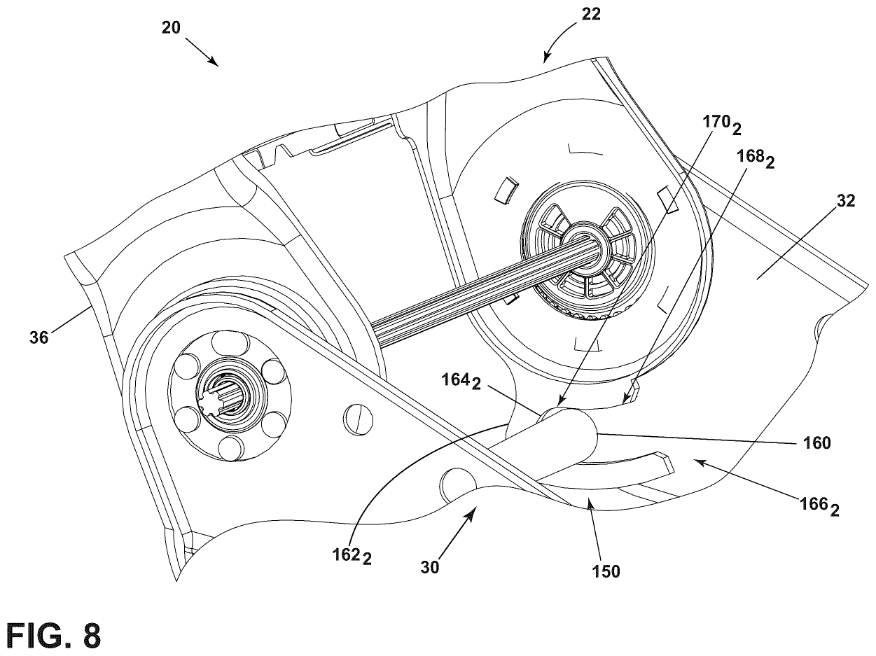

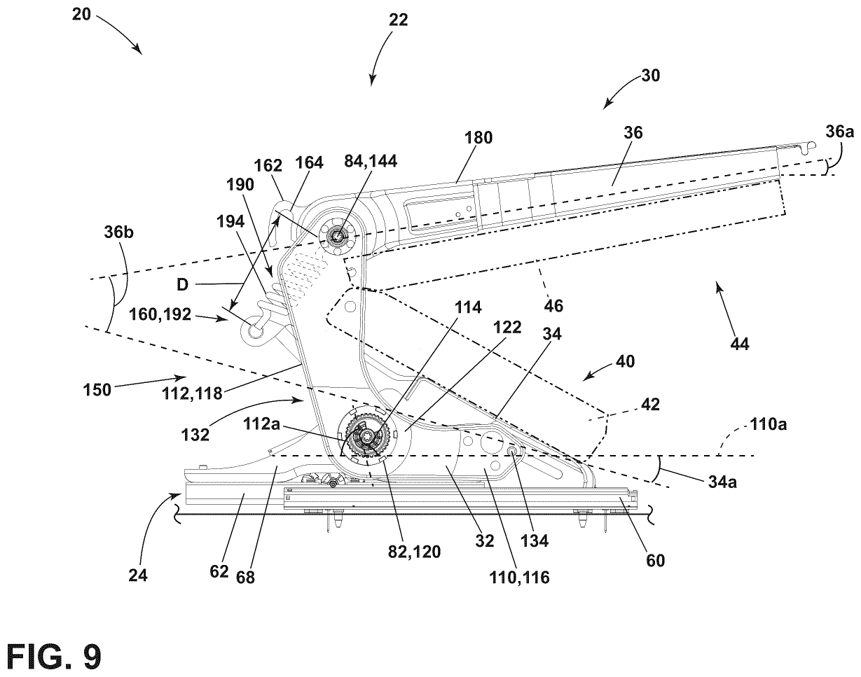

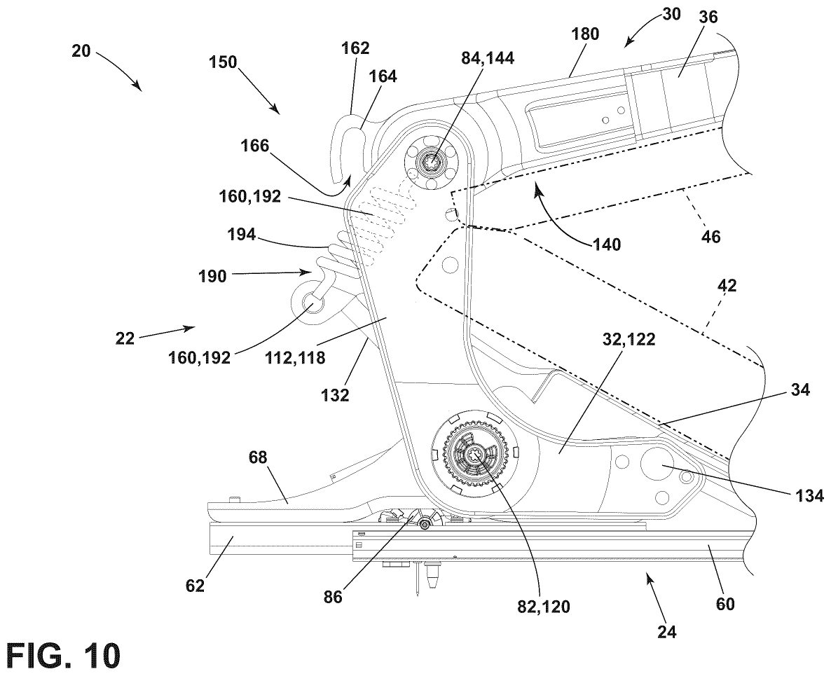

Referring to FIGS. 3-10, the seat 22 and/or the frame assembly 30 include a plurality of positions, such as a design position (FIGS. 3 and 4), a reclined position (FIGS. 5 and 6), an easy-entry position (FIGS. 7 and 8), and/or a folded position (FIGS. 9 and 10). An electronic controller 100 may be operably coupled to and operate the motor assembly 80 to move (e.g., automatically) the seat 22 and/or the frame assembly 30 to and between each of the plurality of positions.

Referring to FIG. 3, the base frame 32 can include a first leg 110 and a second leg 112 disposed at angle 114 relative to each other (e.g., a V-shaped configuration). In some embodiments, the angle 114 is a right angle or an obtuse angle. The angle 114 may, for example and without limitation, be about 95 to 125 degrees. The first leg 110 extends generally forward and includes a first/front end 116 of the base frame 32. The second leg 112 extends generally rearward and includes a second/rear end 118 of the base frame 32. The seat bottom frame 34 is rotatably coupled with first leg 110 and/or the first end 116 at a rotation axis 134. A middle portion 122 of the base frame 32 connects the first leg 110 with the second leg 112. The middle portion 122 is rotatably coupled to the second track 62, such as via the mounting bracket 68. The middle portion 122 may be rotatably coupled and/or aligned with a middle section 124 of the second track 62. In some examples, the middle section 124 may include a middle 15% of a length 62L of the second track 62 that may be centered at the midpoint of the length 62L. The rotation axis 120, which may extend parallel to a transverse direction Y, may be aligned with the middle section 124 and/or the midpoint.

With some configurations, the base frame 32 includes an additional base frame section comprising additional first and second legs 1102, 1122 connected by an additional middle portion 1222, which can be configured in the same or a similar manner as the first and second legs 110, 112, and the middle portion 122, respectively (see, e.g., FIGS. 1 and 2). The additional base frame section can be disposed at an opposite side of the frame assembly 30 and rotatably coupled with the additional second track 622 via the additional mounting bracket 682 such that the additional base frame section can rotate about the rotation axis 120.

In some examples, the base frame 32 may be coupled to the second tracks 62, 622 at the rotation axis 120 and the seat 22 may not otherwise be coupled to the second track 62, 622. For example, the frame assembly 30 may not include a separate latching or locking mechanism for selectively coupling with the second tracks 62, 622, the first tracks 60, 602, and/or the mounting surface 64.

Referring again to FIG. 3, the seat bottom frame 34 includes a first end or portion 130 (e.g., a front portion) and a second end or portion 132 (e.g., a rear portion). The seat bottom frame 34 (e.g., the first end or portion 130) is rotatably coupled to the first leg 110 and/or the first end 116 of the base frame 32 at a rotation axis 134. The rotation axis 134 can be parallel to the transverse direction Y. The seat bottom frame 34 can be rotatably coupled with the base frame 32 such that the seat bottom frame 34 rotates with the base frame 32 about the rotation axis 120, and/or such that the seat bottom frame 34 can rotate relative to the base frame 32 about the rotation axis 134. In some examples, the seat bottom frame 34 includes a seat pan.

The seatback frame 36 includes a first end 140 and a second end 142. The seatback frame 36 (e.g., the first end 140) is rotatably coupled to the second leg 112 and/or the second end 118 of the base frame 32 at a rotation axis 144, such as via the second motor 84. The seatback frame 36 can be rotatably coupled with the base frame 32 such that the seatback frame 36 rotates with the base frame 32 about the rotation axis 120, such as upon actuation of the first motor 82, and/or such that the seatback frame 36 can rotate relative to the base frame 32 about the rotation axis 144, such as upon actuation of the second motor 84.

Referring to FIGS. 3 and 4, the seat 22 and/or the frame assembly 30 includes a coupling 150 that selectively engages the seat bottom frame 34 with the seatback frame 36 and disengages the seat bottom frame 34 from the seatback frame 36. The coupling 150 is configured to transfer forces (e.g., the weight of an occupant/cargo) from the seat bottom frame 34 to the seatback frame 36 and/or the base frame 32 when the seat bottom frame 34 is engaged with the seatback frame 36. The coupling 150 includes a first portion 152 provided at the second end or portion 132 of the seat bottom frame 34 and a second portion 154 provided at the first end 140 of the seatback frame 36. In some configurations, one of the first and second portions 152, 154 includes a shaft 160 and the other of the first and second portions 152, 154 includes a hook 162. The examples of FIGS. 3-10 illustrate the first portion 152 including the shaft 160 and the second portion 154 including the hook 162, but that configuration can be reversed with the first portion 152 include the hook 162 and the second portion 154 including the shaft 160.

The shaft 160 can include one or more of a variety of configurations. For example, the shaft 160 can extend parallel to a transverse direction Y and include a solid configuration, a hollow configuration, or a combination of a solid and hollow configuration (e.g., solid where it engages the hook 162 and hollow in other areas). The hook 162 can include a slot 164 having an open end 166 that allows for insertion of the shaft 160 and removal of the shaft 160 from the slot 164. In a design position of the frame assembly 30, the slot 164 may extend generally in the longitudinal direction X. When the shaft 160 is disposed at least partially in the slot 164, the hook 162 may restrict and/or substantially prevent rotation of the seat bottom frame 34 relative to the base frame 32 and the seat bottom frame 34 is engaged with the seatback frame 36. For example, in the design position and the reclined position, the shaft 160 may be disposed in the slot 164 such that the hook 162 substantially prevents downward movement (e.g., counterclockwise rotation in FIGS. 2 and 3) of the seat bottom frame 34, such as when an occupant is seated on the first cushion 42. When the shaft 160 is not disposed in the slot 164, the hook 162 may not restrict downward movement of the seat bottom frame 34, and the seat bottom frame 34 may be disengaged from the seatback frame 36. For example, when moving to the folded position, the seatback frame 36 may rotate forward such that the shaft 160 moves out of the slot 164 through the open end 166 to disengage the seat bottom frame 34 from the seatback frame 36, which may allow the seat bottom frame 34 to move downward. In some configurations, the slot 164 may not include features that restrict movement of the shaft 160 into or out of the open end 166. For example, the open end 166 may be open in all positions of the frame assembly 30 and may not be latched/locked, which may allow rotation of the seatback frame 36 alone, such as via the second motor 84, to cause disengagement between seat bottom frame 34 and the seatback frame 36 (e.g., without actuation of locks, latches, actuators, clips, etc.).

In some configurations, the coupling 150 includes a second hook 162₂ (see, e.g., FIGS. 2 and 8). The second hook 162₂ is connected to a opposite side, in a transverse direction Y, of the seatback frame 36 from the (first) hook 162 and includes a slot 164₂ with an open end 166₂. The second hook 162₂ can be configured in the same or a similar manner as the hook 162. With some examples, the shaft 160 extends to both sides of the seatback frame 36 and can be inserted into and removed from both slots 164, 164₂ at the same time. In other examples, the shaft 160 includes separate portions that can be inserted into and removed from both slots 164, 164₂ at the same time.

A design position of the frame assembly 30 is generally illustrated in FIGS. 3 and 4. In the design position, the seat bottom frame 34 and the seatback frame 36 are disposed in seating positions. The design position may include an active seating position in which an occupant would be generally upright. In some configurations, in the design position, the seat bottom frame 34 and/or a first cushion 42 may be generally horizontal, which may, for example, include being disposed at an angle 34a of about −10 degrees (below) to about 25 degrees (above) relative to horizontal. In some configurations, in the design position, the seatback frame 36 and/or the second cushion 46 may, for example, be disposed at an angle 36a in the range of about 0 degrees (vertical) to about −25 degrees (reclined) relative to vertical. The base frame 32 may be positioned to facilitate the seat bottom frame 34 and/or the seatback frame 36 being in the positions described above. In some examples, in the design position, the first leg 110 is disposed at angle 110a of about 35 to 70 degrees relative to horizontal, and/or the second leg 112 is disposed at an angle 112a of about 10 to 30 degrees relative to horizontal. An angle 36b between the seat bottom frame 34 and the seatback frame 36 may be about 80 to 100 degrees.

In the design position, the rotation axis 134 (e.g., a second rotation axis) may be disposed at a greater height (e.g., from the mounting surface 64) than the rotation axis 120 (e.g., a second rotation axis) and/or the rotation axis 144 (e.g., a third rotation axis). Additionally or alternatively, the rotation axis 144 may be disposed at a greater height than the rotation axis 120. The intersection 48 of the cushions 42, 46 may be disposed at a greater height than the rotation axis 144 when the frame assembly 30 is in the design position.

Referring to FIG. 4, the seat bottom frame 34 is engaged with the seatback frame 36, and the coupling 150 is generally illustrated with the shaft 160 disposed in a first slot portion 168 when the frame assembly 30 is in the design position. The first slot portion 168 may be disposed at or proximate the open end 166. A second slot portion 170 is disposed inward of the first slot portion 168. As the shaft 160 is disposed in the slot 164 when the frame assembly 30 is in the design position, the seat bottom frame 34 is engaged with the seatback frame 36 and the hook 162 restricts downward movement of the seat bottom frame 34, such as to support the weight of an occupant.

A reclined position of the frame assembly 30 is generally illustrated in FIGS. 5 and 6. In the reclined position, the seat bottom frame 34 and the seatback frame 36 are disposed in seating positions. The reclined position may include a relaxed seating position in which an occupant would be reclined and/or comfort of the occupant would be increased relative to the design position. For example and without limitation, the reclined position may be configured as a zero-gravity position that may more evenly distribute gravitational forces on the body of an occupant across the surface of the seat 22 (e.g., the cushions 42, 46) compared to the design position in which a large portion (e.g., a majority) of gravitational forces may be applied through the spine to a relatively small area of the seat 22 (e.g., a portion of the first cushion 42).

In the reclined position, some or all of the base frame 32, the seat bottom frame 34, and the seatback frame 36 are reclined relative to their respective positions in the design position. In some examples of the reclined position, the seat bottom frame 34 is disposed at an angle 34a of at least 25 degrees relative to horizontal, and/or an angle 36b between the seat bottom frame 34 and the seatback frame 36 is at least 95 degrees. The base frame 32 may be positioned to facilitate the seat bottom frame 34 and/or the seatback frame 36 being in the positions described above. In some examples, in the reclined position, the first leg 110 is disposed at angle 110a of at least 60 degrees relative to horizontal, and/or the second leg 112 is disposed at an angle 112a of 20 degrees or less relative to horizontal. With some configurations of the reclined position, the second leg 112 may be substantially horizontal.

In the reclined position, the rotation axis 134 may be disposed at a greater height than when the frame assembly 30 is in the design position, and/or may be disposed at a greater height than the rotation axis 120 and/or the rotation axis 144. Additionally or alternatively, the rotation axis 144 may be disposed at a height that is closer to the height of the rotation axis 120 than when the frame assembly 30 is in the design position. The height of the rotation axis 120 may be fixed relative to the mounting surface 64.

Referring to FIG. 6, the seat bottom frame 34 is engaged with the seatback frame 36, and the coupling 150 is generally illustrated with the shaft 160 disposed in the second slot portion 170 when the frame assembly 30 is in the reclined position. As the shaft 160 is disposed in the slot 164, the seat bottom frame 34 is engaged with the seatback frame 36 and the hook 162 restricts downward movement of the seat bottom frame 34, such as to support the weight of an occupant.

An easy-entry position of the frame assembly 30 is generally illustrated in FIGS. 7 and 8. In the easy-entry position, the seat bottom frame 34 and the seatback frame 36 are titled forward into non-seating positions, and/or the second track 62 is disposed in a forward position, such as to facilitate entry of occupants/or cargo to the space behind the seat 22. In some configurations of the easy-entry position, the seat bottom frame 34 may be disposed at angle 34a of at least −15 degrees, at least −20 degrees, and/or at least −25 degrees relative to (e.g., below) horizontal, among other angles. In some configurations of the easy-entry position, the seatback frame 36 may be titled forward of vertical, such as at angle 36a of at least 10 degrees, and/or at least 15 degrees, among other angles. The base frame 32 may be positioned to facilitate the seat bottom frame 34 and/or the seatback frame 36 being in the positions described above. In some examples, in the easy-entry position, the first leg 110 is disposed at an angle 110a of about 15 to −15 degrees relative to horizontal, and may be substantially horizontal. Additionally or alternatively, in some examples of the easy-entry position, the second leg 112 is disposed at an angle 112a of about 55 to 90 degrees relative to horizontal. A difference in rotational position of the base frame 32 between the reclined position and the easy-entry position of the frame assembly 30 may, in some examples, be at least 45 degrees, at least 50 degrees, or other values. A difference in the angle 34a of the seat bottom frame 34 between the reclined position and the easy-entry position of the frame assembly 30 may be at least 50 degrees, at least 55 degrees, or other values.

With some configurations, movement of the frame assembly 30 into the easy-entry position may involve a greater change in an angle 34a of the seat bottom frame 34 relative to horizontal than a change in an angle 36a of the seatback frame 36 relative to vertical. Such a configuration may result in the shaft 160 of a coupling 150 moving from a first slot portion 168, 168₂ of the slot(s) 164, 164₂ of the hook(s) 162, 162₂ toward and/or into a second slot portion(s) 170, 170₂ of the slot(s) 164, 164₂ (see, e.g., the shaft 160 in the second slot portion 170₂ of the slot 164₂ in FIG. 8), and the seat bottom frame 34 being engaged with the seatback frame 36. With some other configurations, such as configurations in which the seatback frame 36 tilts farther forward to reach the easy-entry position, the shaft 160 and/or the hook 162 may move such that the shaft 160 is out of the slot 164 and the seat bottom frame 34 disengages the seatback frame 36. As the easy-entry position may not be a seating position, engagement between the seat bottom frame 34 and the seatback frame 36 may not be utilized for supporting the weight of an occupant or cargo when the frame assembly 30 is in the easy-entry position, in some examples.

In the easy-entry position, the rotation axis 134 may be disposed at a lower height than when the frame assembly 30 is in the design position, and/or may be disposed at a lower height than the rotation axis 144. Additionally or alternatively, the rotation axis 134 may be disposed at a height that is closer to the height of the rotation axis 120 than when the frame assembly 30 is in the design position. In some configurations, the height of the rotation axes 120, 134 may be substantially the same in the easy-entry position. Additionally or alternatively, the rotation axis 144 may be disposed at a greater height than when the frame assembly 30 is in the design position.

A folded position of the frame assembly 30 is generally illustrated in FIGS. 9 and 10. In the folded position, the seat bottom frame 34 and the seatback frame 36 are tilted forward and folded forward, respectively, into non-seating positions, and/or the second track 62 may be rearward position relative to the first track 60, such as to facilitate additional storage (e.g., on and/or above the rear surface 180 of the seatback 44).

In some configurations of the folded position, the seat bottom frame 34 is disposed at angle 34a that is below horizontal, and the angle 34a may be smaller (e.g., closer to horizontal) than in the easy-entry position. In some configurations of the folded position, the seatback frame 36 may be titled forward to a substantially horizontal position, such as at an angle 36a of 15 degrees or less, 10 degrees or less, and/or 5 degrees or less, among other angles, relative to horizontal. A difference in the angle 36a of the seatback frame 36 between the reclined position and the folded position of the frame assembly 30 may be at least 115 degrees, at least 125 degrees, or other values. The base frame 32 may be positioned to facilitate the seat bottom frame 34 and the seatback frame 36 being in the positions described above. In some examples, the base frame 32 is disposed in the same position in the easy-entry and folded positions.

Moving the frame assembly 30 from another position to the folded position may include rotating the base frame 32 to its forwardmost position and/or rotating the seatback frame 36 toward its forwardmost position, such as via the motor assembly 80. As the seatback frame 36 rotates forward toward horizontal, the hook 162 may move relative to the shaft 160 such that the shaft 160 moves to the first position, from the first position through the open end 166, and/or out of and away from the slot 164 such that the seat bottom frame 34 is not engaged with the seatback frame 36.

With some examples, the first cushion 42 and the second cushion 46 are connected to the frame assembly 30 such that rotation of the seatback frame 36 into the folded position causes the seat bottom frame 34 to rotate and disengage the seatback frame 36. For example, as the seatback frame 36 moves toward the folded position, the second cushion 46 may apply a generally downward force to a rear portion of the first cushion 42. While the coupling 150 is in a coupled state (e.g., with the shaft 160 in the slot 164), the coupling 150 can prevent downward movement of the seat bottom frame 34. Once the coupling 150 is uncoupled, such as when the seatback frame 36 moves toward or to the folded position, the coupling 150 may not restrict downward movement of the seat bottom frame 34, and the force applied by the second cushion 46 to the first cushion 42 may cause the seat bottom frame 34 to move generally downward, which may include rotating about the rotation axis 134 (e.g., counterclockwise in FIGS. 9 and 10). Without such a decoupling of the seat bottom frame 34 and the seatback frame 36, the contact between the first and second cushions 42, 46 may restrict movement of the seatback frame 36, which could limit its folded position to larger angles above horizontal, which may be undesirable (e.g., allow for less storage space).

In the folded position, the rotation axes 120, 134, 144 may be disposed at the same or similar heights as in the easy-entry position.

Referring to FIG. 10, the seat bottom frame 34 is disengaged from the seatback frame 36, and the shaft 160 is outside of the slot 164 and disposed at a distance D from the hook 162. The distance D can include a vertical distance and may correspond to the thickness and/or density of the first cushion 42 and/or the second cushion 46. For example, thicker and/or denser cushions 42, 46 may result in a greater distance D.

In some embodiments, the seat bottom frame 34 is connected to the base frame 32 and/or the seatback frame 36 via a biasing member 190. The biasing member 190 can include a spring and/or a plurality of springs, among other configurations. The biasing member 190 may, for example, include a first end 192 connected to the seat bottom frame 34 at or about the second end 142, which may include be connected to the shaft 160. The biasing member 190 may, for example, include a second end 194 connected to the base frame 32, such as at or about the second end 118, and/or to the seatback frame 136, such as at or about the first end 140. The biasing member 190 may bias the second end 142 of the seat bottom frame 34 toward the second end 118 of the base frame 32 and/or toward the first end 140 of the seatback frame 36. Additionally or alternatively, the biasing member 190 may bias the shaft 160 toward the hook 162 and/or the slot 164, at least to some degree. If the force applied by the second cushion 46 to the first cushion 42, which may be provided at least in part via the motor assembly 80 (e.g., the second motor 84), as the seatback frame 36 rotates toward the folded position, is larger than a biasing force of the biasing member 190, the second cushion 46 may cause movement of the first cushion 42 and the second end or portion 132 of the seat bottom frame 34. For example, the second motor 84 may act against and overcome a biasing/spring force of the biasing member 190 as the second motor 84 rotates the seatback frame 36 into the folded position. As the seatback frame 36 rotates back toward other positions, the biasing member 190 may cause the second end 142 to move upward, and/or cause the shaft 160 to move toward and/or into the slot 164 of the hook 162.

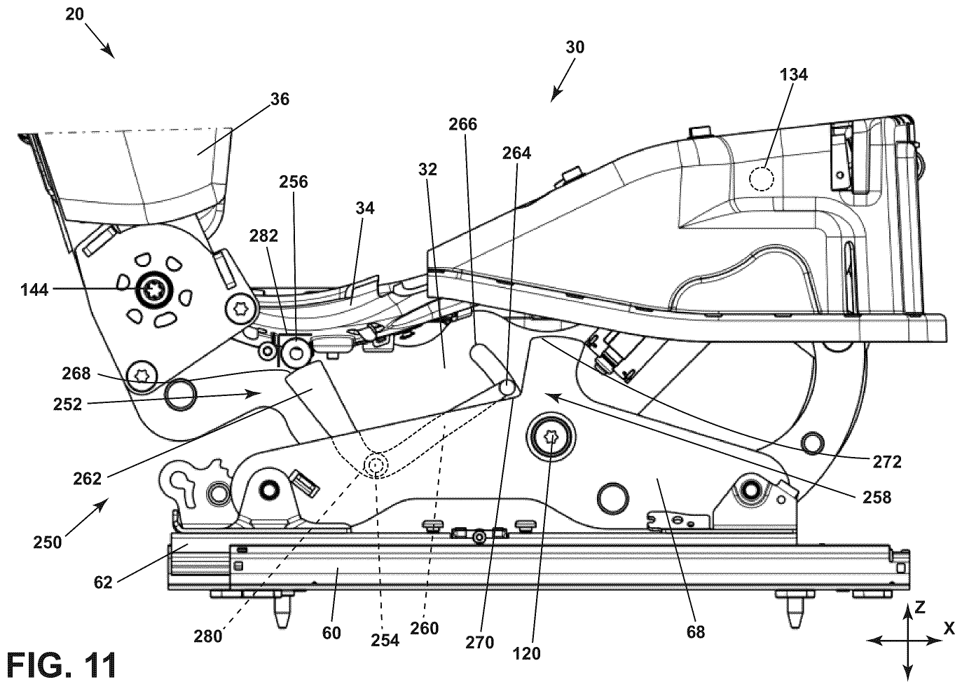

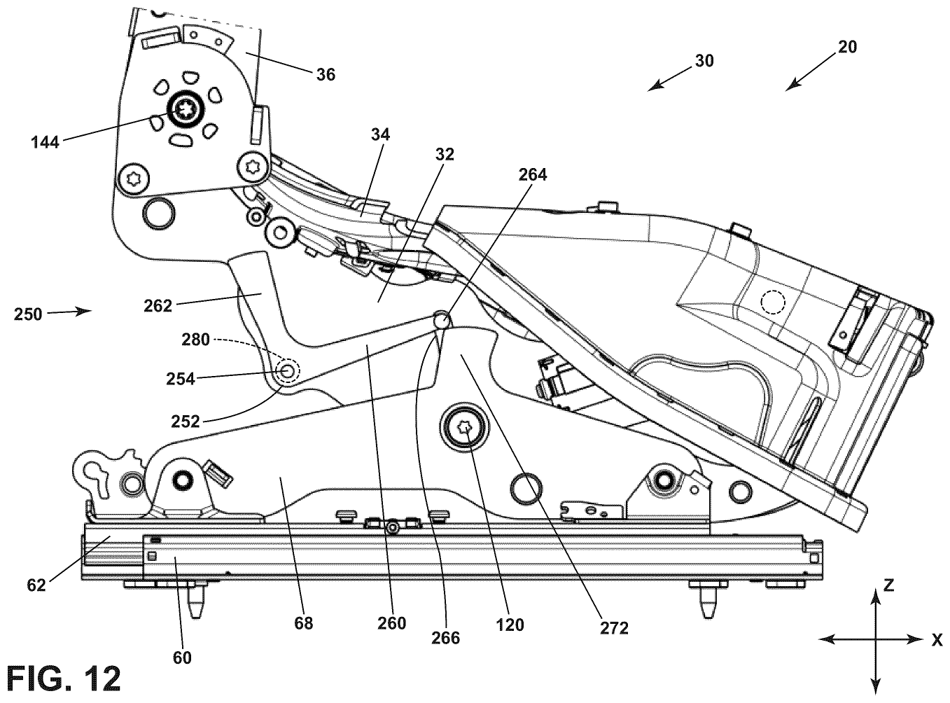

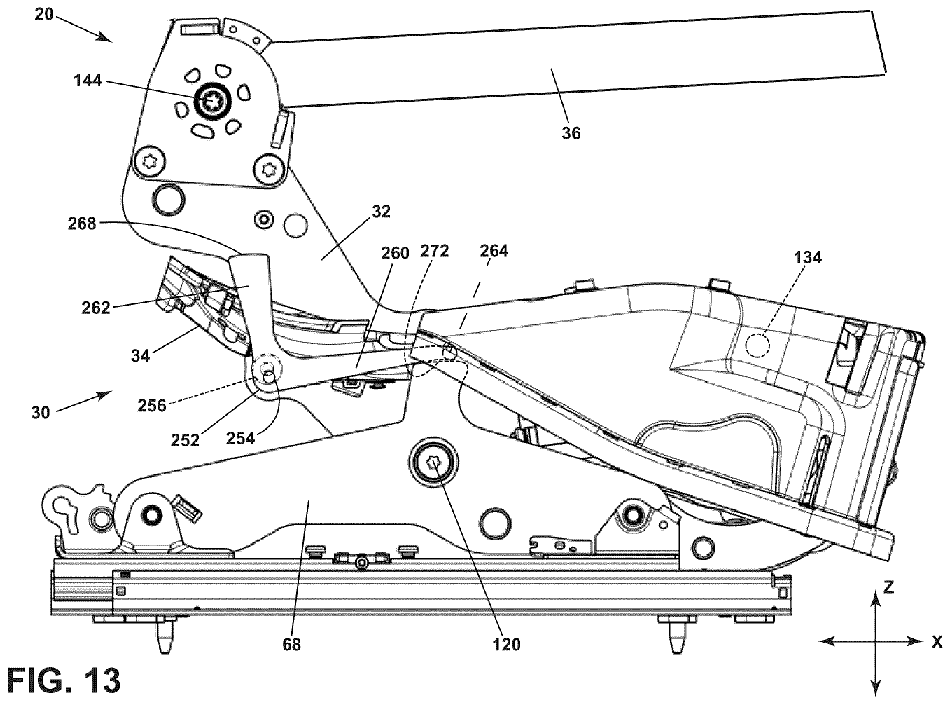

FIGS. 11-15 illustrate a coupling 250 that selectively couples the rear portion 132 (e.g., a rear portion) of the seat bottom frame 34 with the base frame 32 such that the rear portion 132 is selectively engaged with and/or supported by the base frame 32. The coupling 250 includes a lever 252 rotatably coupled to the base frame 32 at a rotation axis 254, a shaft 256 coupled to the seat bottom frame 34, and/or a cam 258 coupled to the mounting bracket 68. The cam 258 includes a first cam portion 270 and a second cam portion 272. The second cam portion 272 has a greater height relative to the mounting surface 64 than the first cam portion 270. The lever 252 includes a first position in which the lever 252 is engaged with the shaft 256 (see, e.g., FIG. 11), The lever 252 includes one or more second positions in which the lever 252 is disengaged from the shaft 256 (see, e.g., FIGS. 12 and 13). Rotation of the base frame 32 controls movement of the lever 252 between the first position and the second position. The rear portion 132 of the seat bottom frame 34 is engaged with and/or supported by the base frame 32 when the lever 252 is in the first position. The rear portion 132 of the seat bottom frame 34 is disengaged from and/or not supported by the base frame 32 when the lever 252 is in the second position.

When the frame assembly 30 is in the design position and/or the reclined position, the base frame 32 is disposed such that a protrusion 264 (e.g., a pin, flange, etc.) of the lever 252 is in contact with the first cam portion 270, or not in contact with the cam 258, and is lever 252 is disposed in the first position in which the rear portion 132 of seat bottom frame 34 is engaged with and/or supported by the base frame 32 via the lever 252. As the frame assembly 30 moves toward the folded position, movement of the base frame 32 may cause the protrusion 264 to move along the first cam portion 270 toward the second cam portion 272, which may cause the lever 252 to rotate, at least to some degree. If the lever 252 rotates far enough such that lever 252 (e.g., a flange 284 thereof) is not in contact with the shaft 256 (e.g., to a second position), the rear portion 132 is disengaged from the base frame 32. When the frame assembly 30 is in the folded position, the base frame 32 is disposed such that the lever 252 is in contact with the second cam portion 272 and is disposed in the second position in which the rear portion 132 of seat bottom frame 34 is not engaged with and/or is not supported by the base frame 32. In some configurations, the lever 252 is disposed in a second position, with the coupling 250 disengaged, when the frame assembly 30 is in an easy-entry position. In other configurations, the lever 252 is disposed in the first position, with the coupling 250 engaged, when the frame assembly is in the easy-entry position.

The lever 252 can include a first lever portion 260 and a second lever portion 262 that may be disposed at angle relative to the first lever portion 260. The angle may, for example, be about 45 degrees to about 135 degrees, and in some examples may be about 90 degrees and the lever 252 may include a V-shaped configuration. The first lever portion 260 may include the protrusion 264. The base frame 32 may include a slot 266 in which a second end of the protrusion 264 moves. The first end of the protrusion 264 may contact the cam 258.

The base frame 32 may include a first leg 110 (e.g., a front leg) and a second leg 112 (e.g., a rear leg). The lever 252 may be rotatably coupled to the second leg 112 such that the lever 252 rotates with and relative to the base frame 32. Optionally, the shaft 256 is integrally formed with the rear portion 132 of the seat bottom frame 34. Optionally, the cam 258 is integrally formed with the mounting bracket 68. The coupling 250 may include a spring 280 that biases the lever 252 toward the first position (e.g., an engaged/supporting position). The spring 280 may, at least indirectly, bias the rear portion 132 of the seat bottom frame 34 upward. In some configurations, the base frame 32 includes a stop 282 that restricts movement of the shaft 256 in a first direction, and/or the lever 252 may selectively restrict movement of the shaft 256 in a second direction. The first direction and the second direction may be opposite rotational directions relative to the rotation axis 134. The stop 282 may be fixed to and/or extend from the base frame 32.

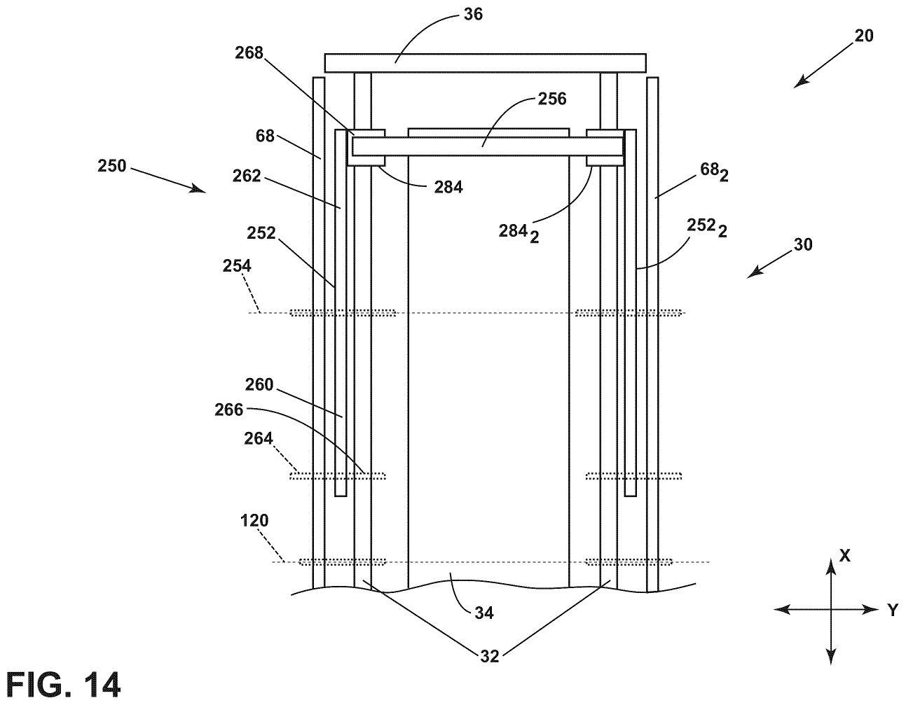

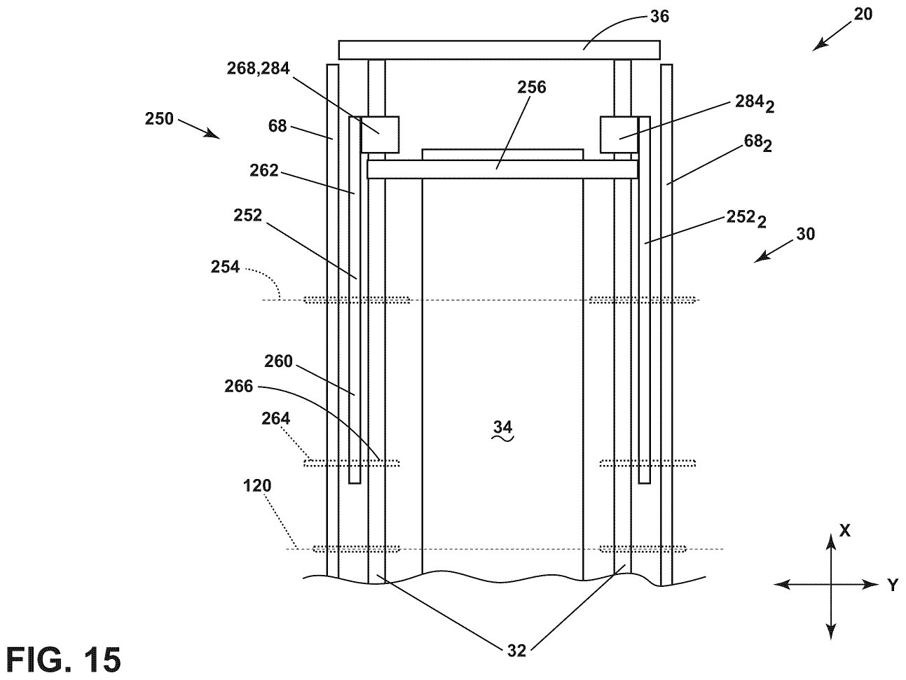

In some examples, such as generally illustrated in FIGS. 14 and 15, the lever 252 includes a flange 284 that extends in a transverse direction Y, is in contact with and/or supports the shaft 256 when the lever 252 is in the first/engaged position (see, e.g., FIG. 14), and/or is not in contact with the shaft 256 when the lever 252 is in the second/disengaged position (see, e.g., FIG. 15). The flange 284 may include the contact surface 268.

With some examples, the coupling 250 may include an additional lever 2522 having and additional flange 2842 disposed at a second side of the frame assembly 30 that may be configured and/or function in the same or a similar manner as the lever 252 and the flange 284.

A seat assembly 20 may include a coupling 150, a coupling 250, or both couplings 150, 250.

Referring to FIGS. 1-13, a method of operating a seat assembly 20 includes the electronic controller 100 controlling movement of the frame assembly 30 to and between a plurality of positions, such as design, reclined, easy-entry, and folded positions, via operating a motor assembly 80. Moving the frame assembly 30 from the design position to or toward the reclined position can include the first motor 82 rotating the base frame 32 rearward about the rotation axis 120 (e.g., counterclockwise in FIGS. 3-6), and/or can include the second motor 84 rotating the seatback frame 36 rearward about the rotation axis 144. Moving the frame assembly 30 from the reclined position or the design position to or toward the easy-entry position can include the first motor 82 rotating the base frame 32 forward about the rotation axis 120 (e.g., clockwise in FIGS. 3-13, and/or can include the second motor 84 rotating the seatback frame 36 forward about the rotation axis 144. The second motor 84 rotating the seatback frame 36 forward into the folded position may cause the coupling 150, 250 to decouple, disengaging the seat bottom frame 34 from base frame 32 and/or the seatback frame 36, and allowing the seat bottom frame 34 to rotate downward about the rotation axis 134, such as to compensate for contact/interference between the first and second cushions 42, 46.

While FIGS. 3-13 are side views showing portions of one side of examples of a seat assembly 20 for illustrative purposes, a seat assembly 20 can include additional portions, including a mirrored portion, at a second side of the seat assembly 20, such as generally illustrated in FIGS. 1 and 2. The mirrored portion may include some or all of the same components and/or respective complementary portions thereof, of those shown in FIGS. 3-13. Also, the side views shown FIGS. 3, 5-7, 9 and 10 include a cross-sectional view of the seat bottom frame 34 to facilitate illustration of other portions.

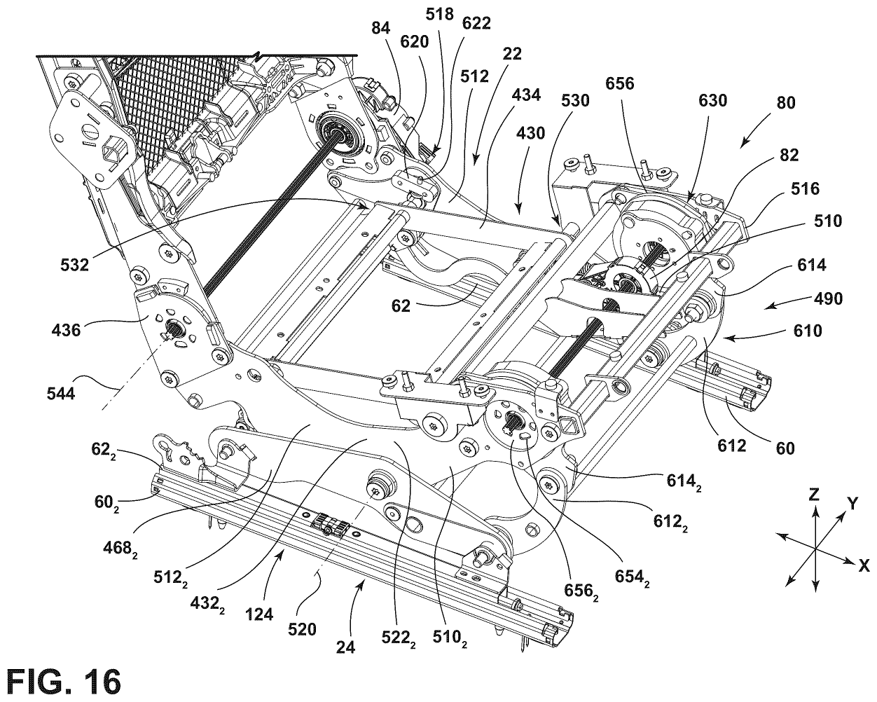

Referring to FIG. 16, a perspective view illustrates the seat assembly 20, the seat 22, and/or the track assembly 24, with the seat 22 including a frame assembly 430. The frame assembly 430 can, for example, be utilized instead of the frame assembly 30 or in addition to the frame assembly 30 of FIGS. 1-15 (e.g., if the seat assembly 20 includes multiple seats 22). The frame assembly 430 includes a base frame 432, a seat bottom frame 434, a seatback frame 436, and/or a bracket 468. For example, the seat bottom 40 (FIG. 1) can include the seat bottom frame 434 and the first cushion 42 (FIG. 1), and the seatback 44 (FIG. 1) can include the seatback frame 436 and the second cushion 46 (FIG. 1). The bracket 468 connects the frame assembly 430 and the seat 22 to the second track 62 that is slidably mounted to the first track 60. With some configurations, the bracket 468 is rigidly fixed to the second track 62. The base frame 432 is rotatably coupled to the bracket 468 such that the base frame 432 rotates about a rotation axis 520 and such that the base frame 432 is rotatably coupled to the second track 62 via the bracket 468.

The seat assembly 20 and/or the frame assembly 430 includes a base frame adjuster 490. The first motor 82 of the motor assembly 80 is included with or coupled to the base frame adjuster 490 to move (e.g., rotate) the base frame 432 relative to the bracket 468. The base frame adjuster 490 includes a linkage 610 and a coupling 630. The second motor 84 of the motor assembly 80 is coupled with the seatback frame 436 to rotate the seatback frame 436 relative to the base frame 432 and/or to rotate the base frame 432 relative to the seatback frame 436. In some configurations, the second motor 84 is attached to the base frame 432 such that the seatback frame 436 rotates relative to the second motor 84. In some other configurations, the second motor 84 is attached to the seatback frame 436 such that the second motor 84 moves with the seatback frame 436 relative to the base frame 432. Optionally, the second motor 84 includes and/or is connected to one or both of the base frame 432 or the seatback frame 436 via a recliner.

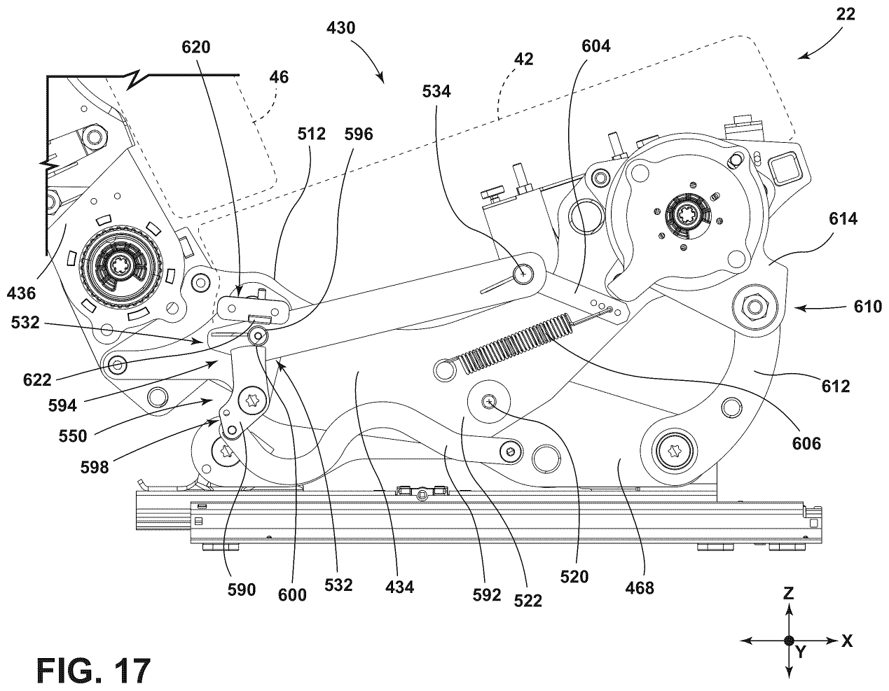

The base frame 432 can include a similar configuration as the base frame 32. For example, the illustrated base frame 432 includes a first leg 510 and a second leg 512 disposed at angle relative to each other (e.g., a V-shaped configuration). The first leg 510 extends generally forward and includes a first/front end 516 of the base frame 432. The second leg 512 extends generally rearward and includes a second/rear end 518 of the base frame 432. The seat bottom frame 434 is rotatably coupled with the first leg 510 and/or the first end 516 at a rotation axis 534 (FIG. 17). A middle portion 522 of the base frame 432 connects the first leg 510 with the second leg 512. The middle portion 522 is rotatably coupled to the second track 62, such as via the bracket 468. The middle portion 522 may be rotatably coupled and/or aligned with a middle section 124 of the second track 62.

With some configurations, the base frame 432 includes an additional base frame section comprising first and second legs 5102, 5122 connected by a middle portion 5222, which can be configured in the same or a similar manner as the first and second legs 510, 512, and the middle portion 522, respectively. The additional base frame section can be disposed at an opposite side of the frame assembly 430 and rotatably coupled with the second track 622 via a second mounting bracket 4682 such that the additional base frame section can rotate about the rotation axis 520.

The seat bottom frame 434 includes a first end 530 (e.g., a front end) and a second end 532 (e.g., a rear end). The seat bottom frame 434 (e.g., the first end 530) is rotatably coupled to the first leg 510 and/or the first end 516 of the base frame 432 at a rotation axis 534. The rotation axis 534 can be parallel to the transverse/lateral direction Y. The seat bottom frame 434 can be rotatably coupled with the base frame 432 such that the seat bottom frame 434 rotates with the base frame 432 about the rotation axis 520, and/or such that the seat bottom frame 434 can rotate relative to the base frame 432 about the rotation axis 534. In some examples, the seat bottom frame 434 includes or is coupled to a seat pan.

The seatback frame 436 is rotatably coupled to the second leg 512 and/or the second end 518 of the base frame 432 at a rotation axis 544, such as via the second motor 84. The seatback frame 436 can be rotatably coupled with the base frame 432 such that the seatback frame 436 rotates with the base frame 432 about the rotation axis 520, such as upon actuation of the first motor 82, and/or such that the seatback frame 436 can rotate relative to the base frame 432 about the rotation axis 544, such as upon actuation of the second motor 84.

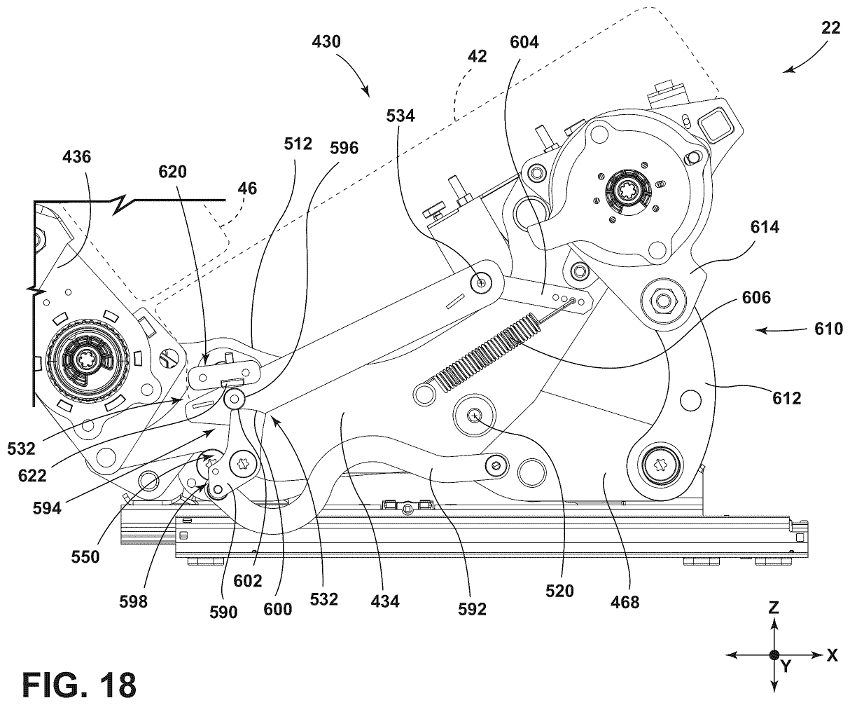

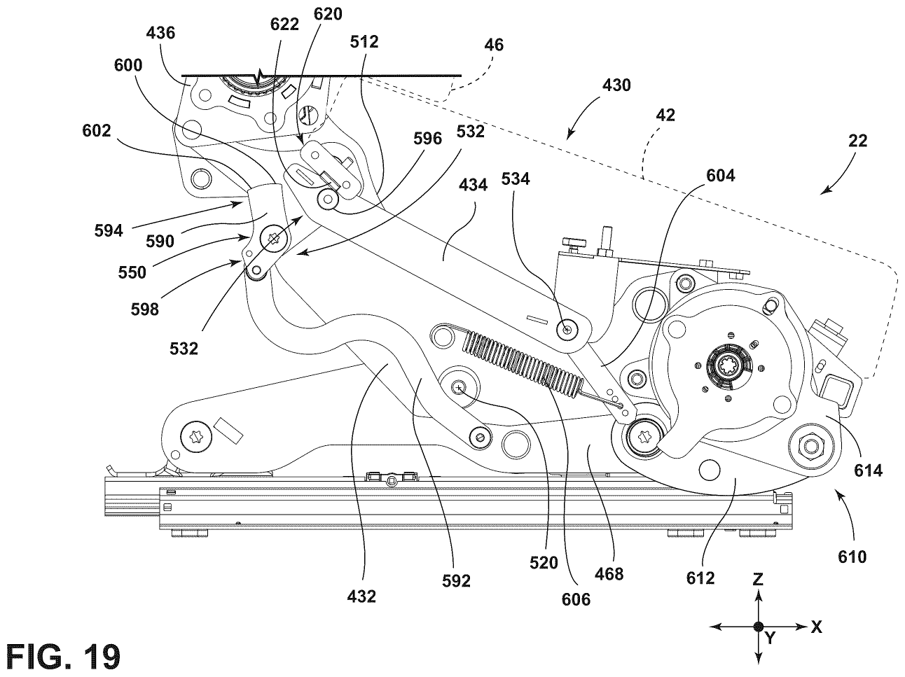

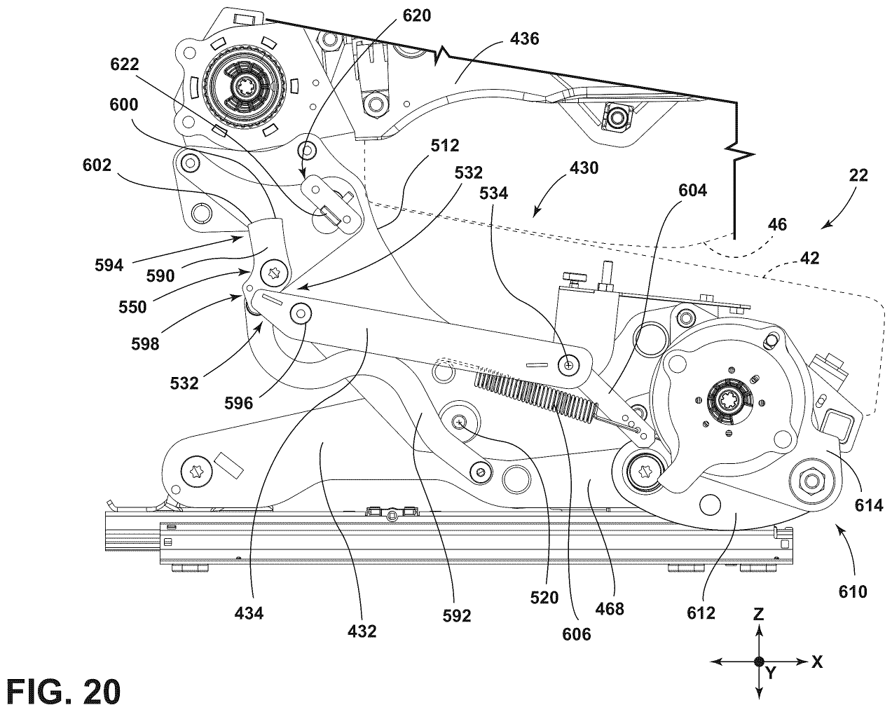

Referring to FIGS. 17-20, the seat 22 and/or the frame assembly 430 include a plurality of positions, such as a design position (FIG. 17), a reclined position (FIG. 18), and/or an easy-entry position (FIG. 19), and/or a folded position (FIG. 20). An electronic controller 100 (FIG. 1) may be operably coupled to and operate the motor assembly 80 to move (e.g., automatically) the seat 22 and/or the frame assembly 430 to and between each of the plurality of positions.

Referring to FIG. 17, the design position of the frame assembly 430 of the seat assembly 20 is generally illustrated. In the design position, the seat bottom frame 434 and the seatback frame 436 are disposed in seating positions. A coupling 550 selectively couples with and/or supports the seat bottom frame 434 (e.g., the second/rear end 532 of the seat bottom frame 434), such as to compensate for contact/interference between the first and second cushions 42, 46 (e.g., in the folded position). For example, the coupling 550 can allow for movement of the seat bottom frame 434 in a similar manner as the coupling 250 described in connection with FIGS. 11-15. The coupling 550 includes a cam 590 and a link 592 (e.g., a lever). The cam 590 is rotatably coupled with the base frame 432 (e.g., at the second leg 512) such that the cam 590 rotates with the base frame 432 and relative to the base frame 432. The link 592 is rotatably coupled with the bracket 468 and rotatably coupled with the cam 590. The link 592 optionally includes an S-shaped configuration. In the design position, a first end 594 of the cam 590 is in contact with a portion 596 of the seat bottom frame 434. The link 592 is rotatably coupled to a second end 598 of cam 590. The portion 596 is illustrated as a roller, but can include other configurations. The first end 530 of the seat bottom frame 434 is rotatably connected to the base frame 432 (e.g., at the first leg 510) such that the seat bottom frame 434 rotates with the base frame 432 about the rotational axis 520 and relative to the base frame 432 about the rotational axis 534. The portion 596 is disposed at the second end 532 (e.g., a rear end) of the seat bottom frame 434. In some examples, the second end 532 and/or the portion 596 are not directly coupled with the base frame 432, the seatback frame 436, or the bracket 468. For example, the second end 532 can function as a free end. In the design position, the portion 596 rests on the first end 594 of the cam 590 such that the cam 590 supports at least some of the load (e.g., the weight of an occupant and/or cargo) on the seat bottom frame 434. In the design position, the portion 596 is in contact with a forward section 600 of the first end 594. Optionally, a stop 620 is coupled to the base frame 432 to limit upward movement of the portion 596 and the second end 532. For example, the stop 620 can be fixed to the second leg 512 of the base frame 432 to limit clockwise rotation of the seat bottom frame 434. The stop 620 can include an arm 622 biased (e.g., by a spring) toward the cam 590 to bias the portion 596 into contact with the first end 594, at least while the frame assembly 430 is in the design position and the reclined position.

As the seat 22 and/or the frame assembly 430 rotates from the design position of FIG. 17 rearward to or toward the reclined position of FIG. 18, the link 592 limits rotation of the cam 590 such that the cam 590 remains in substantially the same orientation (e.g., rotates 20 degrees or less, 10 degrees or less, or other values) relative to the track assembly 24 as the base frame 432, the seat bottom frame 434, and the seatback frame 436 rotate rearward, and the portion 596 moves (e.g., rolls) rearward from the forward section 600 to a rear section 602 of the first end 594 of the cam 590. For example, the forward section 600 and the rear section 602 of the first end 594 can remain substantially horizontal in some or all positions of the seat 22 and/or the frame assembly 430. While the portion 596 is in contact with the first end 594, including the forward section 600 and the rear section 602, the cam 590 supports the second end 532 of the seat bottom frame 434 such that the seat bottom frame 434 remains in a seating position.

As the seat 22 and/or the frame assembly 430 rotates from the design position of FIG. 17 to or toward the easy entry position of FIG. 19, the seat bottom frame 434 moves (e.g., rotates) with the base frame 432 while the link 592 limits the rotation of the cam 590 relative to the track assembly 24, and the portion 596 moves forward off of the first end 594 of the cam 590 such that the second end 532 of the seat bottom frame 434 is not supported by the cam 590 (e.g., the seat bottom frame 434 is disengaged from the base frame 432), which allows the second end 532 to rotate down (e.g., counterclockwise in FIGS. 17-20). As the seat 22 and/or the frame assembly 430 moves toward the folded position of FIG. 20, such as via rotating the seatback frame 436 forward, the second cushion 46 contacts the first cushion 42, causing downward rotation of the second end 532. Such rotation of the second end 532 can compensate for contact/interference between the first cushion 42 and the second cushion 46, such as in a similar manner as described above in connection with the couplings 150 (FIGS. 2-10), 250 (FIGS. 11-15). The seat bottom frame 434 includes a seat bottom lever 604 extending from the first end 530. A spring 606 couples the seat bottom lever 604 with the base frame 432 to bias (e.g., rotationally) the second end 532 upward (e.g., clockwise in FIGS. 17-20). For example, the spring 606 biases the portion 596 toward the stop 620. With such a configuration, folding of the second cushion 46 with the seatback frame 436 into contact with the first cushion 42 will cause downward movement of the first cushion 42 (e.g., counterclockwise rotation) when the folding force exceeds a spring force of the spring 606. The spring 606 acts to move the portion 596 above or into contact with the first end 594 of the cam 590 as the seat 22 and/or the frame assembly 430 move from the easy entry position toward the design position.

Referring to FIGS. 16-20, the frame assembly 430 includes a linkage 610 coupling the first leg 510 of the base frame 432 with the bracket 468, such as in addition to the rotatable coupling at the rotation axis 520. The linkage 610 enables, at least in part, powered actuation of the frame assembly 430 to move the frame assembly 430 to and between the reclined, design, and easy entry positions. The linkage 610 includes a first lever 612 (e.g., a first coupling lever) rotatably coupled to the bracket 468, and a second lever 614 (e.g., a second coupling lever) rotatably coupled to the first lever 612 and the base frame 432, such as to the first leg 510 and/or the first end 516. Optionally, the linkage includes a first lever 6122 and a second lever 6142 configured in the same or similar manner as the first lever 612 and the second lever 614, respectively, and disposed at an opposite side of the seat 22 (e.g., with a mirrored configuration). The linkage 610 is configured such that rotation of the second lever 614 causes rotation of the first lever 612, which causes the base frame 432 to rotate about the rotation axis 520. In the illustrated example, clockwise rotation of the second lever 614 causes counterclockwise rotation of the first lever 612, which lifts the first end 516 of the base frame 434 upward and rotates the base frame 432 counterclockwise about the rotation axis 520 to or toward the reclined position. Counterclockwise rotation of the second lever 614 causes clockwise rotation of the first lever 612, which lowers the first end 516 of the base frame 432 and rotates the base frame 432 clockwise about the rotation axis to or toward the easy entry position.

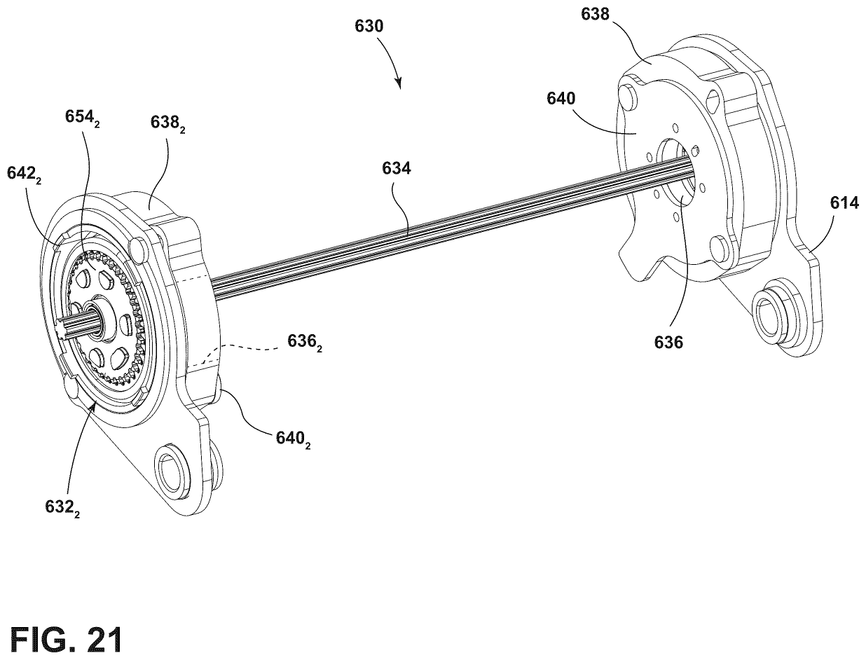

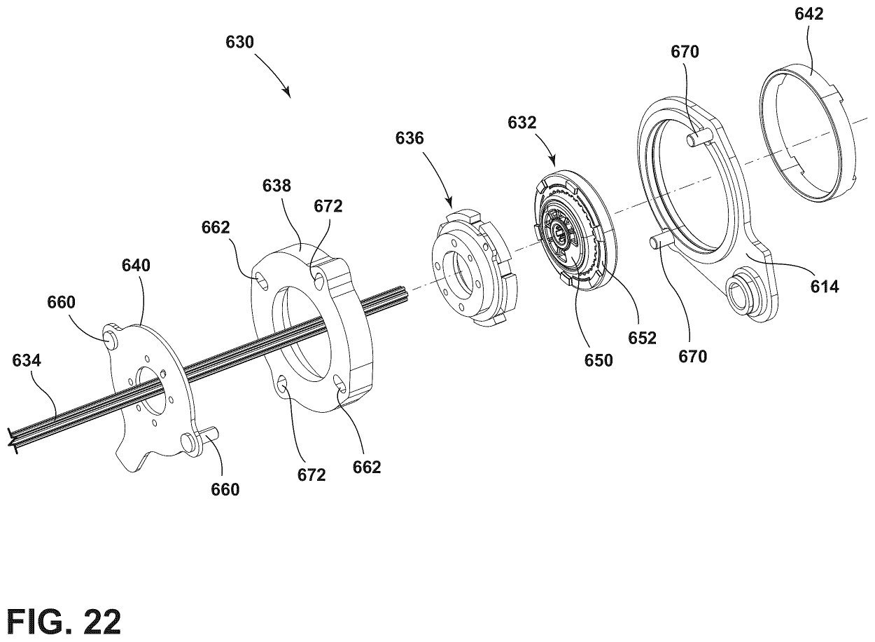

With further reference to FIG. 16, the seat 22 and/or the frame assembly 430 includes the coupling 630 (e.g., a motor coupling). The coupling 630 operably couples the first motor 82 with the linkage 610 to cause and/or control rotation of the second lever 614 to cause and/or control rotation of the base frame 432. A perspective view and an exploded of the coupling 630 with the second lever 614 are illustrated in FIGS. 21 and 22, respectively. The coupling 630 includes a recliner 632 (FIG. 22), a rod 634, a spacer 636, a coupling plate 638, a recliner lever 640, and/or a rod ring 642 (FIG. 22). The rod 634 extends through the recliner 632, the spacer 636, the coupling plate 638, the recliner lever 640, the rod ring 642, and/or the second lever 614. The coupling 630 can include a second recliner 6322, a second spacer 6362, a second coupling plate 6382, a second recliner lever 6402, and/or a second rod ring 6422 that can be disposed on or about the rod 634. The second recliner 6322, the second spacer 6362, the second coupling plate 6382, the second recliner lever 6402, and/or the second rod ring 6422 disposed at an opposite lateral side from and/or include mirrored configurations of the recliner 632, the coupling plate 638, the recliner lever 640, and/or the rod ring 642, respectively. Descriptions of the recliner 632, the coupling plate 638, the recliner lever 640, and/or the rod ring 642 can also apply to the second recliner 6322, the second spacer 6362, the second coupling plate 6382, the second recliner lever 6402, and/or the second rod ring 6422, respectively.

The first motor 82 (FIG. 16) is operably coupled with the rod 634 such that operation of the first motor 82 rotates the rod 634. The recliner 632 is coupled with the rod 634 such that rotation of the rod 634 causes rotation of at least a portion of the recliner 632. The recliner 632 includes a first portion 650 coupled to the rod 634 and a second portion 652 operably coupled with the first portion 650 such that rotation of the rod 634 causes rotation (e.g., eccentric rotation) of the second portion 652. The recliner 632 includes a third portion that is coupled (e.g., fixed) to the base frame 432 (FIG. 16). For example, a third portion 6542 of the second recliner 6322 is illustrated in FIGS. 16 and 21, and can be coupled (e.g., fixed) to the base frame 432 via a coupling bracket 6562. The third portion of the recliner 632 can be configured in same manner as the third portion 6542, disposed in a mirrored orientation relative to the third portion 6542, and coupled (e.g., fixed) to the base frame 432 via a coupling bracket 656 (FIG. 16). The third portion 6542 is coupled (e.g., fixed to the second base frame 4322 via the coupling bracket 6562.

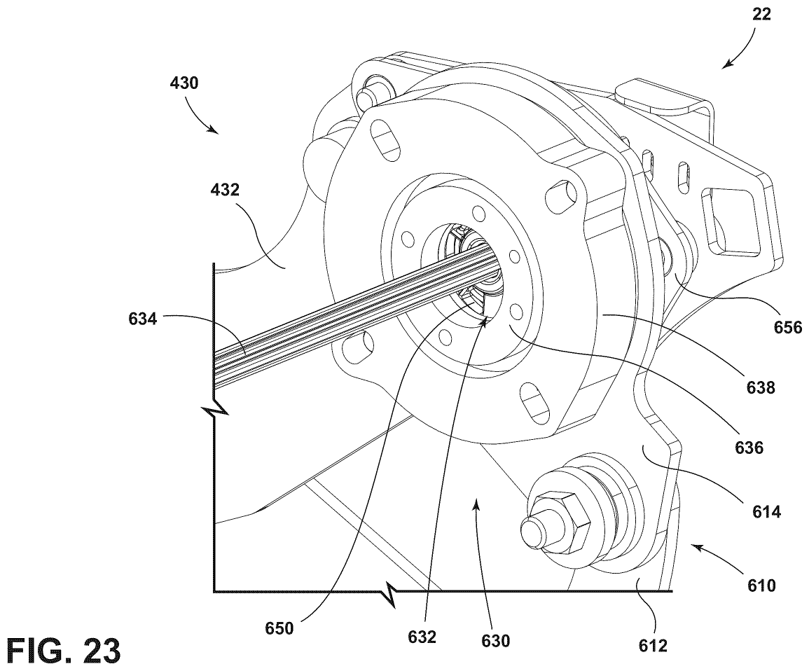

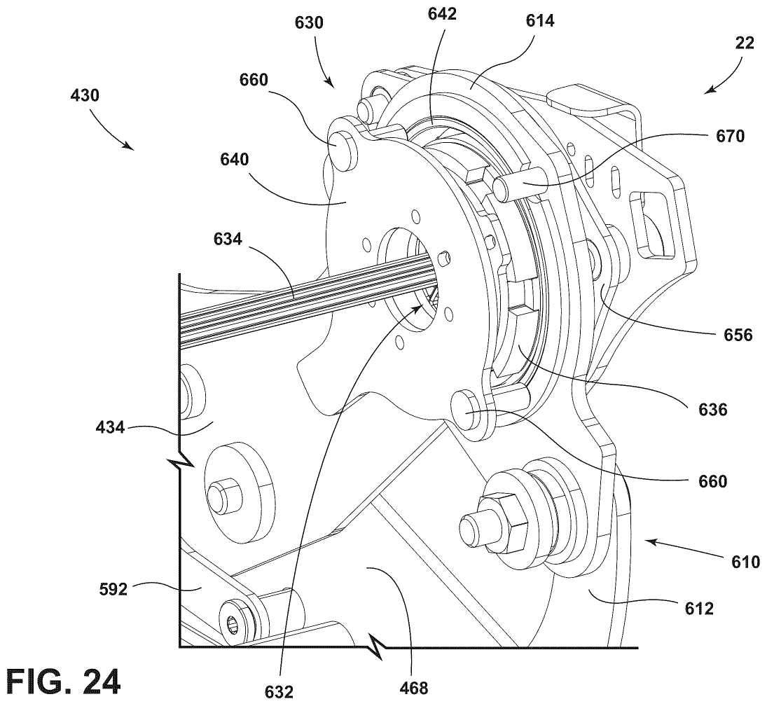

The second portion 652 is coupled with the recliner lever 640 via the spacer 636. Optionally, the coupling 630 excludes the spacer 636 and the second portion 652 is directly coupled to the recliner lever 640. The spacer 636 can allow for a reduced size of the subassembly of the recliner 632, the spacer 636, the coupling plate 638, the recliner lever 640, and the second rod ring 6422. The spacer 636 extends through the center of the coupling plate 638 (FIG. 23) and transmits the eccentric rotation of the second portion 652 to the recliner lever 640 (FIG. 24). For example, the spacer 636 can be welded to the recliner lever 640 and/or the second portion 652 of the recliner 632. The spacer 636 is not directly coupled with the coupling plate 638. The recliner lever 640 includes one or more recliner lever pins 660 that extend parallel to the rod 634 (e.g., parallel to the transverse direction Y) into corresponding first slots 662 in the coupling plate 638. The first slots 662 are elongated in the radial direction, relative to the rod 634, such that rotation of the recliner lever 640 (e.g., eccentric rotation) is transmitted to the coupling plate 638. The second lever 614 of the linkage 610 includes one or more second lever pins 670 that extend into corresponding second slots 672 of the coupling plate 638 that are circumferentially offset from the first slots 662. The one or more second slots 672 are elongated in the radial direction such that the coupling plate 638 converts the eccentric rotation of the recliner 632 and the recliner lever 640 to rotation of the second lever 614 about the rod 634 (e.g., non-eccentric rotation). For example, the coupling 630 converts eccentric rotation of the recliner 632 to less eccentric or non-eccentric rotation of the second lever 614 to rotate the base frame 432 relative to the bracket 468. Reducing or eliminating eccentric rotation can allow of smoother rotation of the base frame 432 as the frame assembly 430 moves to and between the reclined, design, and easy entry positions.

Utilizing the recliner 632 to operably couple the first motor 82 with the second lever 614 can provide for compact packaging, provide high gear reduction, and/or prevent reverse driving (e.g., via weight on the seat 22).

The instant disclosure includes the following non-limiting embodiments:

A seat assembly, comprising a frame assembly, including: a base frame rotatably; a seat bottom frame rotatably coupled with the base frame; and a seatback frame rotatably coupled to the base frame; wherein the frame assembly includes a plurality of positions, including a reclined position, a design position, an easy-entry position, and a folded position; the seat bottom frame is engaged with at least one of the base frame and the seatback frame in the reclined position and the design position; and the seat bottom frame is disengaged from the at least one of the base frame and the seatback frame in the folded position.

The seat assembly of embodiment 1, comprising a track assembly, including: a first track, and a second track slidably coupled with the first track; wherein the base frame is rotatably coupled with the second track.

The seat assembly of any preceding embodiment, wherein the base frame includes a V-shaped configuration; the seat bottom frame is rotatably coupled to a front end of the base frame; the seatback frame is rotatably coupled to a rear end of the base frame; and a middle portion of the base frame is rotatably coupled with the second track.

The seat assembly of any preceding embodiment, wherein the middle portion of the base frame is rotatably coupled with a middle section of the second track.

The seat assembly of any preceding embodiment, wherein the middle section of the second track comprises a middle 15% of a length of the second track.

The seat assembly of any preceding embodiment, wherein the frame assembly includes a coupling via which the seat bottom frame engages the seatback frame; and the coupling includes a shaft and a hook having a slot with an open end; the shaft is disposed at least partially in the slot when the seat bottom frame is engaged with the seatback frame; the shaft is disposed outside of the slot when the seat bottom frame is disengaged from the seatback frame; the seat bottom frame includes one of the shaft and the hook; and the seatback frame includes the other of the shaft and the hook.

The seat assembly of any preceding embodiment, wherein the coupling is configured to transfer forces from the seat bottom frame to the seatback frame when the seat bottom frame is engaged with the seatback frame.

The seat assembly of any preceding embodiment, wherein the seat bottom frame is connected to the seatback frame via a spring that biases the shaft toward the slot at least when the seat bottom frame is disengaged from the seatback frame.

The seat assembly of any preceding embodiment, wherein the shaft is disposed in a first portion of the slot when the frame assembly is in the design position; the shaft is disposed in a second portion of the slot when the frame assembly is in the reclined position; and the shaft is not disposed in the slot when the frame assembly is in the folded position.

The seat assembly of any preceding embodiment, comprising: a first cushion connected to the seat bottom frame; and a second cushion connected to the seatback frame; wherein the seatback frame is rotatably coupled with the base frame at a rotational axis; and the rotational axis is disposed at a lower height than an intersection between the first cushion and the second cushion when the frame assembly is in the design position.

The seat assembly of any preceding embodiment, wherein the first cushion and the second cushion are connected to the frame assembly such that rotation of the seatback frame into the folded position causes the seat bottom frame to rotate and disengage the seatback frame.

The seat assembly of any preceding embodiment, comprising a motor assembly coupled with the frame assembly to move the frame assembly between the plurality of positions, the motor assembly including: a first motor coupled with the base frame to rotate the base frame; and a second motor coupled with the seatback frame to rotate the seatback frame.

The seat assembly of any preceding embodiment, wherein operation of the second motor to rotate the seatback frame when the frame assembly moves to the folded position causes the seat bottom frame to disengage the seatback frame.

The seat assembly of any preceding embodiment, comprising a track assembly, including: a first track, and a second track slidably coupled with the first track; wherein the base frame is rotatably coupled with the second track; the first motor is coupled with the base frame to rotate the base frame relative to the second track; and the motor assembly includes a third motor coupled with track assembly to move the second track and the frame assembly relative to the first track.

The seat assembly of any preceding embodiment, wherein a difference in rotational position of the base frame between the reclined position and the easy-entry position of the frame assembly is at least 45 degrees.

The seat assembly of any preceding embodiment, wherein a difference in a seatback frame angle of the seatback frame between the reclined position and the folded position of the frame assembly is at least 115 degrees.

The seat assembly of any preceding embodiment, wherein a difference in a seat bottom frame angle of the seat bottom frame between the reclined position and the easy-entry position of the frame assembly is at least 50 degrees.

The seat assembly of any preceding embodiment, wherein the base frame includes a V-shaped configuration having a first leg and a second disposed at an obtuse angle.

The seat assembly of any preceding embodiment, comprising an electronic controller and a motor assembly coupled with the seat frame; wherein the electronic controller is operably coupled with the motor assembly to automatically move the frame assembly between the plurality of positions.

The seat assembly of any preceding embodiment, wherein the reclined position is a zero-gravity position in which (i) the seat bottom frame is disposed at an angle of at least 25 degrees relative to horizontal; and (ii) an angle between the seat bottom frame and the seatback frame is at least 95 degrees.

The seat assembly of any preceding embodiment, wherein the frame assembly includes a coupling via which a rear portion of the seat bottom frame selectively engages and/or is selectively supported by the base frame; the coupling includes a lever rotatably coupled to the base frame, a shaft coupled to the seat bottom frame, and a cam coupled to the base frame; the cam rotates with the base frame; the lever includes a first position in which the lever is engaged with the shaft, and a second position in which the lever is disengaged from the shaft; rotation of the cam controls movement of the lever between the first position and the second position; the rear portion of the seat bottom frame is engaged with and/or supported by the base frame when the lever is in the first position; and the rear portion of the seat bottom frame is disengaged from and/or not supported by the base frame when the lever is in the second position.

The seat assembly of any preceding embodiment, wherein the cam is integrally formed with a mounting bracket; and the base frame is rotatably coupled to the mounting bracket.

The seat assembly of any preceding embodiment, wherein the lever includes a flange that extends in a transverse direction, is in contact with and supports the shaft when the lever is in the first position, and is not in contact with the shaft when the lever is in the second position.

The seat assembly of any preceding embodiment, wherein the base frame includes a front leg and a rear leg; and the lever is rotatably coupled to the rear leg such that the lever rotates with and relative to the base frame.

The seat assembly of any preceding embodiment, wherein the shaft is integrally formed with the rear portion of the seat bottom frame.

The seat assembly of any preceding embodiment, wherein the coupling includes a spring biasing the lever toward the first position.

The seat assembly of any preceding embodiment, wherein the base frame includes a stop that restricts movement of the shaft in a first direction; and the lever selectively restricts movement of the shaft in a second direction.

The seat assembly of any preceding embodiment, wherein the first direction and the second direction are opposite rotational directions.

The seat assembly of any preceding embodiment, wherein the lever is configured to limit rotation of the cam during rotation of the base frame.

The seat assembly of any preceding embodiment, wherein the frame assembly includes a stop to limit upward movement of a rear end of the seat bottom frame.

The seat assembly of any preceding embodiment, wherein the stop includes an arm biasing the rear end into contact with the cam in the reclined and design positions.

The seat assembly of any preceding embodiment, wherein the frame assembly includes: a coupling lever rotatably coupled to the base frame and including one or more coupling lever pins; and a motor coupling comprising: a rod; a recliner coupled to the rod and the base frame; a recliner lever coupled to recliner and including one or more recliner lever pins; and a coupling plate coupled to the recliner lever and the coupling lever, the coupling plate including one or more first slots in which the one or more coupling lever pins are partially disposed and one or more second slots in which the one or more recliner lever pins are partially disposed.

The seat assembly of any preceding embodiment, wherein the motor coupling includes a spacer that couples the recliner to the recliner plate, the spacer extending through the coupling plate.

The seat assembly of any preceding embodiment, wherein the one or more first slots and the one or more second slots are elongated in the radial direction to covert eccentric rotation of the recliner to non-eccentric rotation of the coupling lever.

The seat assembly of any preceding embodiment, wherein the frame assembly includes a motor coupled to the rod.

An electronic controller configured to operate the seat assembly of any preceding embodiment.

A non-transitory computer-readable storage medium having a computer program encoded thereon for operating the seat assembly of any preceding embodiment.

In examples, a controller (e.g., the electronic controller 100) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising.” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

What is claimed is:

1. A seat assembly, comprising
a frame assembly, including:
a base frame;
a seat bottom frame rotatably coupled with the base frame; and
a seatback frame rotatably coupled to the base frame;
wherein the frame assembly includes a plurality of positions, including a reclined position, a design position, an easy-entry position, and a folded position;
the seat bottom frame is engaged with at least one of the seatback frame and the base frame in the reclined position and the design position; and
the seat bottom frame is disengaged from the at least one of the seatback frame or the base frame in the folded position.

2. The seat assembly of claim 1, comprising a track assembly, including:
a first track, and
a second track slidably coupled with the first track;
wherein the base frame is rotatably coupled with the second track.

3. The seat assembly of claim 2, wherein the base frame includes a V-shaped configuration with a front leg, a rear leg, and a middle portion between the front leg and the rear leg;
the seat bottom frame is rotatably coupled to the front leg;
the seatback frame is rotatably coupled to the rear leg; and
the middle portion is rotatably coupled with the second track.

4. The seat assembly of claim 3, wherein the middle portion of the base frame is rotatably coupled with a middle section of the second track.

5. The seat assembly of claim 1, wherein the frame assembly includes a coupling via which the seat bottom frame engages the seatback frame; and
the coupling includes a shaft and a hook having a slot with an open end;
the shaft is disposed at least partially in the slot when the seat bottom frame is engaged with the seatback frame;
the shaft is disposed outside of the slot when the seat bottom frame is disengaged from the seatback frame;
the seat bottom frame includes one of the shaft and the hook; and
the seatback frame includes the other of the shaft and the hook.

6. The seat assembly of claim 5, wherein the coupling is configured to transfer forces from the seat bottom frame to the seatback frame when the seat bottom frame is engaged with the seatback frame.

7. The seat assembly of claim 6, wherein the seat bottom frame is connected to the seatback frame via a spring that biases the shaft toward the slot at least when the seat bottom frame is disengaged from the seatback frame.

8. The seat assembly of claim 5, wherein the shaft is disposed in a first portion of the slot when the frame assembly is in the design position;
the shaft is disposed in a second portion of the slot when the frame assembly is in the reclined position; and
the shaft is not disposed in the slot when the frame assembly is in the folded position.

9. The seat assembly of claim 1, comprising:
a first cushion connected to the seat bottom frame; and
a second cushion connected to the seatback frame;
wherein the seatback frame is rotatably coupled with the base frame at a rotational axis; and
the rotational axis is disposed at a lower height than an intersection between the first cushion and the second cushion when the frame assembly is in the design position.

10. The seat assembly of claim 9, wherein the first cushion and the second cushion are connected to the frame assembly such that rotation of the seatback frame into the folded position causes the seat bottom frame to rotate and disengage the seatback frame or the base frame.

11. The seat assembly of claim 1, comprising a motor assembly coupled with the frame assembly to move the frame assembly between the plurality of positions, the motor assembly including:
a first motor coupled with the base frame to rotate the base frame; and
a second motor coupled with the seatback frame to rotate the seatback frame.

12. The seat assembly of claim 11, wherein operation of the second motor to rotate the seatback frame to move the frame assembly to the folded position causes the seat bottom frame to disengage the seatback frame.

13. The seat assembly of claim 1, wherein a difference in rotational position of the base frame between the reclined position and the easy-entry position of the frame assembly is at least 45 degrees.

14. The seat assembly of claim 13, wherein a difference in a seatback frame angle of the seatback frame between the reclined position and the folded position of the frame assembly is at least 115 degrees.

15. The seat assembly of claim 14, wherein a difference in a seat bottom frame angle of the seat bottom frame between the reclined position and the easy-entry position of the frame assembly is at least 50 degrees.

16. The seat assembly of claim 1, wherein the reclined position is a zero-gravity position in which (i) the seat bottom frame is disposed at an angle of at least 25 degrees relative to horizontal; and (ii) an angle between the seat bottom frame and the seatback frame is at least 95 degrees.

17. The seat assembly of claim 1, wherein the frame assembly includes a coupling via which a rear portion of the seat bottom frame selectively engages and/or is selectively supported by the base frame;
the coupling includes a lever rotatably coupled to the base frame, and a cam coupled to the base frame; and
the cam rotates with the base frame.

18. The seat assembly of claim 17, wherein the coupling includes a shaft coupled to the seat bottom frame;
the lever includes a first position in which the lever is engaged with the shaft, and a second position in which the lever is disengaged from the shaft;
rotation of the cam controls movement of the lever between the first position and the second position;
the rear portion of the seat bottom frame is engaged with and/or supported by the base frame when the lever is in the first position; and
the rear portion of the seat bottom frame is disengaged from and/or not supported by the base frame when the lever is in the second position.

19. The seat assembly of claim 17, wherein the lever is configured to limit rotation of the cam during rotation of the base frame.

20. The seat assembly of claim 1, wherein the frame assembly includes:
a coupling lever rotatably coupled to the base frame and including one or more coupling lever pins; and
a motor coupling comprising:
a rod;
a recliner coupled to the rod and the base frame;
a recliner lever coupled to recliner and including one or more recliner lever pins; and
a coupling plate coupled to the recliner lever and the coupling lever, the coupling plate including one or more first slots in which the one or more coupling lever pins are partially disposed and one or more second slots in which the one or more recliner lever pins are partially disposed.
